(19) United States
(12) Patent Application Publication
(10) Pub. No.: US 2016/0340603 A1
(43) Pub. Date: Nov. 24, 2016

(54) LUBRICATING OIL COMPOSITION FOR DIFFERENTIAL GEAR UNIT

(71) Applicants: JX NIPPON OIL & ENERGY CORPORATION, Tokyo (JP); JTEKT CORPORATION, Osaka-shi (JP)

(72) Inventors: Kazutoshi TAKAHASHI, Tokyo (JP); Noriko AYAME, Tokyo (JP); Yasushi ONUMATA, Tokyo (JP); Hiroyuki ANDO, Osaka-shi (JP); Junji ANDO, Osaka-shi (JP); Yozo YAMASHITA, Osaka-shi (JP); Toshimi HARA, Osaka-shi (JP); Takuya TSUDA, Osaka-shi (JP)

(21) Appl. No.: 15/111,058

(22) PCT Filed: Oct. 31, 2014
(86) PCT No.: PCT/JP2014/079109

§ 371 Date: Jul. 12, 2016

(30) Foreign Application Priority Data
Jan. 14, 2014 (JP) 2014-004157

(51) Int. Cl. C10M 169/04; C10M 105/32; C10M 105/04; F16H 48/38; F16H 48/10; F16H 48/285; F16H 48/29; F16H 57/04; C10M 101/02; C10M 133/16

(52) U.S. Cl. CPC C10M 169/04; C10M 101/02; C10M 105/32; C10M 105/04; C10M 133/16; F16H 48/10; F16H 48/285; F16H 48/29; F16H 57/0483; F16H 48/38; C10N 2230/76; C10N 2230/06; C10N 2230/02; C10N 2240/04; C10M 2203/024; C10M 2203/1006; C10M 2215/086; C10M 2215/082; C10M 2207/283; C10M 2207/126; C10M 2215/04; C10M 2219/044; C10M 2223/043

(57) ABSTRACT

Provided is a lubricating oil composition for a differential gear unit that is effective in limiting the generation of noise and vibrations even when a limited-slip differential is operated. The lubricating oil composition contains (A) a mineral oil and/or (B) a synthetic oil and (C) a friction modifier selected from amide- and imide-based friction modifiers and derivatives thereof in an amount of 0.01 to 10 percent by mass on the basis of the total mass of the composition. Also provided is a differential gear unit that is lubricated with the lubricating oil composition.

### TECHNICAL FIELD

The present invention relates to a lubricating oil composition for a differential gear unit and particularly to a lubricating oil composition for a differential gear unit with a limited-slip differential.

### BACKGROUND ART

The differential gear unit is a device that typically allows for a difference between the speeds of rotation of left and right wheel shafts (a difference between the speeds of the rotation of the front and rear wheel shafts for a center differential gear unit, but this is not referred hereinafter), and some differential gear units are mounted with a limited-slip differential that functions to distribute the input torque to the left and right shafts. When the ground contact areas of the left and right wheels are subjected to different friction or when an automobile is turned, causing a difference in rotational speed between the right and left wheel shafts, a simple differential gear unit increases the rotation speed of the shaft of the wheel on which less resistance is acted. In other words, a problem would arise that a necessary torque is not transmitted to the wheel rotating at a lower speed. A device for solving this problem is a limited-slip differential.

Although the limited-slip differential varies in mechanism, the basic mechanism is such that in response to the difference in rotational speed between the left and right shafts, friction is created therebetween to limit the difference and transmit the necessary torque to the shafts by the resulting frictional force (see, for example, Patent Literature 1 below).

Recently, energy saving in automobiles and construction or agricultural machinery, i.e., fuel saving has become an urgent need in order to deal with environmental issues such as reduction in carbon dioxide emissions, and units such as engines, transmissions, final reduction gears, compressors, or hydraulic power units have been strongly demanded to contribute to energy saving. Consequently, the lubricating oils used in these units are required to be reduced in stir resistance and frictional resistance more than before.

For example, a manual transmission or a final reduction gear unit has a gear bearing mechanism. Reduction of the viscosity of a lubricating oil to be used therein can reduce the stir and frictional resistances and thus enhance the power transmission efficiency, resulting in an improvement in the fuel efficiency of an automobile.

The lubricating oil composition for a differential gear unit is required to have more excellent extreme pressure properties than other gear oil compositions. Particularly, a differential gear unit mounted with a hypoid gear needs a lubricating oil with significantly excellent extreme pressure properties such as those graded as GL4 or better, generally GL5 or better under API classification. Therefore, extremely high quality of techniques regarding additives are required in order to decrease the viscosity of a lubricating oil composition for a differential gear unit while satisfying the required properties (see for example Patent Literature 2 below).

### CITATION LIST

### Patent Literature

Patent Literature 1: Japanese Patent Application Laid-Open Publication No. 6-330069

Patent Literature 2: Japanese Patent Application Laid-Open Publication No. 2010-195894

### SUMMARY OF INVENTION

### Technical Problem

As described above, a limited-slip differential is a device that develops friction between the left and right wheel shafts to control a difference between the left and right rotational speeds, i.e., the left and right transmission torques, but it uses a frictional force and is thus likely to generate noise and vibration at surfaces on which slippage occurs.

When the viscosity of a lubricating oil to be used in a limited-slip differential is decreased to improve the fuel saving properties, it is reduced in fatigue life, or extreme pressure properties and the limited-slip differential is likely to be seized. Thickening of a lubricating oil with a viscosity index improver can improve the viscosity characteristic at low temperatures or practical temperatures but is not generally expected much to improve the fatigue life or extreme pressure properties.

In view of the forgoing current situations, the present invention has an object to provide a lubricating oil composition for a differential gear unit that is effective in suppressing generation of noise or vibration (hereinafter referred to as “anti-NV properties”) even when a limited-slip differential is actuated. Furthermore, the present invention also has an object to provide a lubricating oil for a differential gear unit mounted with a limited-slip differential, having sufficient extreme pressure properties even though it has a low viscosity.

### Solution to Problem

As the results of extensive studies and researches to achieve the above objects, the present invention has been accomplished on the basis of the finding that these objects was able to be achieved with a lubricating oil composition comprising a base oil comprising a specific mineral base oil or a specific synthetic base oil blended with a specific friction modifier.

That is, the present invention relates to a lubricating oil composition for a differential gear unit comprising a base oil comprising (A) a mineral oil and/or (B) a synthetic oil and (C) a friction modifier selected from the group consisting of amide- and imide-based friction modifiers and derivative thereof in an amount of 0.01 to 10 percent by mass on the basis of the total mass of the composition.

The present invention also relates to the foregoing lubricating oil composition for a differential gear unit wherein Component (A) has a 100° C. kinematic viscosity of 3 to 10 mm²/s.

The present invention also relates to the foregoing lubricating oil composition for a differential gear unit wherein Component (B) is (B-1) a poly-α-olefin having a 100° C. kinematic viscosity of 3 to 2000 mm²/s and/or a hydrogenated compound thereof and/or (B-2) an ester base oil having a 100° C. kinematic viscosity of 1.5 to 30 mm²/s.

The present invention also relates to the foregoing lubricating oil composition for a differential gear unit further comprising (D) at least one or more types of friction modifiers selected from the group consisting of carboxylic acids, alcohols, amines and derivatives thereof in an amount of 0.01 to 10 percent by mass on the basis of the total mass of the composition.

The present invention also relates to the foregoing lubricating oil composition for a differential gear unit further comprising (E) a metallic detergent in an amount of 0.0001 to 0.4 percent by mass as metal on the basis of the total mass of the composition.

The present invention also relates to the foregoing lubricating oil composition for a differential gear unit further comprising (F) a sulfur-based extreme pressure additive and (G) a phosphorous-based extreme pressure additive in amounts of 1 to 3 percent by mass as sulfur and 0.01 to 0.3 percent by mass as phosphorous, respectively on the basis of the total mass of the composition.

The present invention also relates to a differential gear unit wherein it has a limited-slip differential limiting differential by allowing sliding members to slide and the sliding members is lubricated with the foregoing lubricating oil compositions.

The present invention also relates to the foregoing differential gear unit wherein the sliding surfaces of the sliding members of the limited-slip differential are treated to have a diamond-like carbon film or a tungsten carbide/diamond-like carbon film formed thereon or are nitrided.

The present invention also relates to the foregoing differential gear unit wherein either the sliding members or the corresponding slid members in the limited-slip differential have sliding surfaces with a diamond-like carbon film or a tungsten carbide/diamond-like carbon film formed thereon and the others have nitrided sliding surfaces.

The present invention also relates to the foregoing differential gear unit wherein the limited-slip differential has planetary gear mechanism.

The present invention also relates to the foregoing differential gear unit wherein it has the foregoing limited-slip differential comprising the planetary gear mechanism comprising a plurality of planetary gears and a planetary carrier supporting the plurality of planetary gears so as to be rotatable on their own rotational axes and orbitally revolvable and the differential of the differential gear unit is limited by sliding of the planetary gears and planetary carrier relative to each other.

### Advantageous Effect of Invention

The lubricating oil composition of the present invention is an extremely useful lubricating oil composition for a differential gear unit which is particularly suitable for a differential gear unit mounted with a limited-slip differential and highly effective in suppressing the generation of noise and vibration and can retain sufficiently high extreme pressure properties while having fuel saving properties with the decreased viscosity.

### BRIEF DESCRIPTION OF DRAWINGS

FIG. 1 is a cross-sectional view of an exemplary differential gear unit mounted with a limited-slip differential.

FIG. 2 is a perspective view of the planetary carrier shown in FIG. 1.

FIG. 3 is a cross-sectional view of the planetary carrier shown in FIG. 1.

FIG. 4 is a cross-sectional view of another exemplary differential gear unit mounted with a limited-slip differential.

FIG. 5 is a cross-sectional view of another exemplary differential gear unit mounted with a limited-slip differential.

FIG. 6 is a cross-sectional view of another exemplary differential gear unit mounted with a limited-slip differential.

### DESCRIPTION OF EMBODIMENTS

The present invention will be described in more detail below.

The lubricating base oil of the lubricating oil composition of the present invention is (A) a mineral base oil and/or (B) a synthetic base oil.

Component (A), i.e., the mineral base oil has a 100° C. kinematic viscosity of preferably 3 mm²/s or higher, more preferably 3.5 mm²/s or higher, more preferably 3.7 mm²/s or higher and preferably 10 mm²/s or lower, more preferably 7 mm²/s or lower.

If Component (A) has a 100° C. kinematic viscosity of lower than 3 mm²/s, it is not preferable because it causes a deterioration in extreme pressure properties or a decrease in fatigue life of bearings and thus possibly degrade the reliability of the system where the resulting composition is used. Whilst, if Component (A) has a 100° C. kinematic viscosity of higher than 10 mm²/s, the resulting composition is increased in viscosity and thus will be deteriorated in fuel saving properties.

The 100° C. kinematic viscosity used herein denotes the value measured in accordance with JIS K 2283.

Component (A) has a % C_{A} of preferably 0.5% or less, more preferably 0.3% or less, more preferably 0.2% or less and most preferably 0. The use of Component (A) having a % C_{A} of 0.5% or less renders it possible to produce a composition with excellent oxidation stability.

The % C_{A} used herein denotes the percentage of the aromatic carbon number in the total carbon number determined by a method (n-d-M ring analysis) in accordance with ASTM D 3238-85.

Component (A) has a % C_{N} of preferably 35% or less, more preferably 33% or less, more preferably 30% or less, particularly preferably 25% or less and preferably 3% or more, more preferably 4% or more, more preferably 5% or more, particularly preferably 6% or more, most preferably 7% or more.

If Component (A) has a % C_{N} of less than 3%, the resulting composition is not sufficient in solubility of additives while if Component (A) has a % C_{N} of more than 35%, the resulting composition would be degraded in oxidation stability and viscosity index.

The % C_{N} used herein denote the percentage of the number of carbons constituting the naphthene cyclic structure in the total carbon number determined by a method (n-d-M ring analysis) in accordance with ASTM D 3238-85.

Component (A) has a tertiary carbon content of preferably 3% or more, more preferably 4% or more.

If the tertiary carbon content is less than 3%, the resulting composition is high in pour point and would become cloudy or be precipitated at room temperature whilst if the tertiary carbon content exceeds 10%, the resulting composition would be decreased in viscosity index.

The percentage of the tertiary carbon in the total amount of the carbon constituting the lubricating base oil used in the present invention refers to the percentage of the total integral intensity of signals attributed to the carbon atoms of tertiary carbon (>CH—) to the total integral intensity of the all carbons, measured by ¹³C-NMR.

In the present invention, the ¹³C-NMR measurement was carried out using a sample wherein 0.5 g of the base oil was diluted with 3 g of deuterated chloroform at room temperature and a resonant frequency of 100 MHz. A gated coupling process was used for the measurement. However, other methods may be used if the equivalent results can be obtained.

In the present invention, the percentage of the tertiary carbon in the all carbons constituting the lubricating base oil is preferably from 5 to 8%, particularly preferably from 6 to 7%. The percentage of the tertiary carbon adjusted within the above-described range results in a lubricating base oil which contains more isoparaffine and is excellent in viscosity temperature characteristics and thermal and oxidation stability.

No particular limitation is imposed on the method of producing Component (A) as long as it has the above-described properties. However, specific examples of the lubricating base oil used in the present invention include those produced by subjecting a feedstock selected from the following base oils (1) to (8) and/or a lubricating oil fraction recovered therefrom to a given refining process and recovering the lubricating oil fraction:

(1) a distillate oil produced by atmospheric distillation of a paraffin base crude oil and/or a mixed base crude oil;

(2) a whole vacuum gas oil (WVGO) produced by vacuum distillation of the topped crude of a paraffin base crude oil and/or a mixed base crude oil;

(3) a wax produced by a lubricating oil dewaxing process and/or a Fischer-Tropsch wax produced by a GTL process;

(4) an oil produced by mild-hydrocracking (MHC) one or more oils selected from oils of (1) to (3) above;

(5) a mixed oil of two or more oils selected from (1) to (4) above;

(6) a deasphalted oil (DAO) produced by deasphalting an oil of (1), (2) (3), (4) or (5);

(7) an oil produced by mild-hydrocracking (MHC) an oil of (6); and

(8) a lubricating oil produced by subjecting a mixed oil of two or more oils selected from (1) to (7).

The above-mentioned given refining process is preferably hydrorefining such as hydrocracking or hydrofinishing, solvent refining such as furfural extraction, dewaxing such as solvent dewaxing and catalytic dewaxing, clay refining with acidic clay or active clay, or chemical (acid or alkali) refining such as sulfuric acid treatment and sodium hydroxide treatment. In the present invention, any one or more of these refining processes may be used in any combination and any order.

The lubricating base oil used in the present invention is particularly preferably the following base oil (9) or (10) produced by subjecting a base oil selected from the above-described base oils (1) to (8) or a lubricating oil fraction recovered therefrom to a specific treatment:

(9) a hydrocracked mineral oil produced by hydrocracking a base oil selected from base oils (1) to (8) or a lubricating oil fraction recovered from the base oil, and subjecting the resulting product or a lubricating oil fraction recovered therefrom by distillation, to a dewaxing treatment such as solvent or catalytic dewaxing, optionally followed by distillation; or

(10) a hydroisomerized mineral oil produced by hydroisomerizing a base oil selected from base oils (1) to (8) or a lubricating oil fraction recovered from the base oil, and subjecting the resulting product or a lubricating oil fraction recovered therefrom by distillation, to a dewaxing treatment such as solvent or catalytic dewaxing, optionally followed by distillation.

When lubricating base oil (9) or (10) is produced, the dewaxing process includes preferably catalytic dewaxing with the objective of further enhancing the thermal/oxidation stability and low temperature viscosity characteristics and also anti-fatigue properties of the resulting lubricating oil composition.

If necessary, a solvent refining process and/or a hydrofinishing process may be carried out at appropriate timing upon production of lubricating base oil (9) or (10).

When catalytic dewaxing (catalyst dewaxing) is carried out, a hydrocracked/hydroisomerized oil is reacted with hydrogen in the presence of an appropriate dewaxing catalyst under effective conditions to decrease the pour point. In the catalytic dewaxing, part of a high boiling point substance in the cracked/isomerized product is converted to a low boiling point substance and the low boiling point substance is separated from a heavier base oil fraction to distillate base oil fractions thereby producing two or more types of lubricating base oils. Separation of the low boiling point substance may be carried out prior to produce the intended lubricating base oil or during distillation.

When catalytic dewaxing (catalyst dewaxing) is carried out, a hydrocracked/hydroisomerized oil is reacted with hydrogen in the presence of an appropriate dewaxing catalyst under effective conditions to decrease the pour point. In the catalytic dewaxing, part of a high boiling point substance in the cracked/isomerized product is converted to a low boiling point substance and the low boiling point substance is separated from a heavier base oil fraction to distillate base oil fractions thereby producing two or more types of lubricating base oils. Separation of the low boiling point substance may be carried out prior to produce the intended lubricating base oil or during distillation.

No particular limitation is imposed on the mineral base oil of Component (A) if the 100° C. kinematic viscosity, % C_{A} and tertiary carbon content meet the above requirements, which is, however, preferably a hydrocracking mineral base oil. Alternatively, Component (A) is also preferably a wax isomerized isoparaffinic base oil produced by isomerizing a feedstock containing 50 percent by mass or more of wax of petroleum or Fischer-Tropsch synthetic oil. These may be used alone or in combination but the sole of use of a wax isomerized base oil is preferable.

No particular limitation is imposed on the viscosity index of Component (A), which is, however, preferably 100 or greater, more preferably 120 or greater, more preferably 130 or greater, particularly preferably 140 or greater, and preferably 200 or less, more preferably 180 or less. The use of a lubricating base oil having a viscosity index of 100 or greater renders it possible to produce a composition exhibiting excellent viscosity characteristics from low temperatures to high temperatures. Whilst, a too great viscosity index is less effective on fatigue life.

No particular limitation is imposed on the aniline point of Component (A), which is, however, preferably 90° C. or higher, more preferably 100° C. or higher, more preferably 110° C. or higher, particularly preferably 115° C. or higher because a lubricating oil composition with excellent low temperature viscosity characteristics and fatigue life can be produced. No particular limitation is imposed on the upper limit of the aniline point, which may, therefore, be 130° C. or higher as one embodiment but is preferably 130° C. or lower, more preferably 125° C. or lower because Component (A) would be more excellent in solubility of additives or sludge and compatibility to sealing materials.

No particular limitation is imposed on the sulfur content of Component (A), which is, however, preferably 0.05 percent by mass or less, more preferably 0.01 percent by mass or less, more preferably 0.005 percent by mass or less. A composition with excellent oxidation stability can be produced by reducing the sulfur content of the lubricating base oil.

The synthetic base oil that is Component (B) of the lubricating oil composition of the present invention is preferably one or more types of base oils selected from (B-1) a poly-α-olefin having a 100° C. kinematic viscosity of 3 mm²/s or higher and 2000 mm²/s or lower and/or a hydrogenated compound thereof and/or (B-2) an ester-based base oil having a 100° C. kinematic viscosity of 1.5 to 30 mm²/s.

Component (B-1), i.e., the poly-α-olefin is preferably an oligomer or cooligomer of an α-olefin having 2 to 32, preferably 6 to 16, particularly preferably 8 to 12 carbon atoms.

No particular limitation is imposed on the method for producing the poly-α-olefin, which may, however, be produced by polymerizing an α-olefin in the presence of for example a complex of aluminum trichloride or boron trifluoride and water, alcohol (ethanol, propanol or butanol), a carboxylic acid or an ester or a Ziegler-Natta catalyst or metallocene catalyst.

Component (B-1) has a 100° C. kinematic viscosity of 3 mm²/s or higher, preferably 4 mm²/s or higher, more preferably 20 mm²/s or higher and 2000 mm²/s or lower, preferably 1000 mm²/s or lower, particularly preferably 300 mm²/s or lower. Component (B-1) with a 100° C. kinematic viscosity of lower than 3 mm²/s is not preferable because the resulting composition would be poor in oil film retaining properties at frictional movable parts such as gears while Component (B-1) with a 100° C. kinematic viscosity of higher than 2000 mm²/s is not preferable because the resulting composition would be decreased in viscosity due to shear.

Component (B-1) is preferably a mixture of (B-1-1) a poly-α-olefin having a 100° C. kinematic viscosity of 3 mm²/s or higher and 15 mm²/s or lower and/or a hydrogenated compound thereof and (B-1-2) a poly-α-olefin having a 100° C. kinematic viscosity of higher than 15 mm²/s and 2000 mm²/s or lower and/or a hydrogenated compound thereof.

Component (B-1-1) has a 100° C. kinematic viscosity of preferably 4 mm²/s or higher, more preferably 5 mm²/s or higher and preferably 13 mm²/s or lower, more preferably 11 mm²/s or lower. Blend of a poly-α-olefin with a 100° C. kinematic viscosity of 3 to 15 mm²/s renders it possible to not only improve the fatigue life of bearings and gears but also significantly improve the fluidity at low temperatures.

Component (B-1-2) has a 100° C. kinematic viscosity of preferably 20 mm²/s or higher, more preferably 30 mm²/s or higher, more preferably 35 mm²/s or higher and preferably 1200 mm²/s or lower, more preferably 300 mm²/s or lower. Blend of a poly-α-olefin with a 100° C. kinematic viscosity of higher than 15 mm²/s and 2000 mm²/s or lower renders it possible to not only improve the fatigue life of bearings and gears but also significantly improve the viscosity of the resulting composition.

Component (B-2) of Component (B) is an ester-based base oil having a 100° C. kinematic viscosity of 1.5 to 30 mm²/s.

The ester referred herein is a fatty acid ester. Specific examples include the following esters of monohydric or polyhydric alcohols and monobasic or polybasic acids:

(a) an ester of a monohydric alcohol and a monobasic acid;

(b) an ester of a polyhydric alcohol and a monobasic acid;

(c) an ester of a monohydric alcohol and a polybasic acid;

(d) an ester of a polyhydric alcohol and a polybasic acid;

(e) a mixed ester of a mixture of a monohydric alcohol and a polyhydric alcohol and a polybasic acid;

(f) a mixed ester of a polyhydric alcohol and a mixture of a monobasic acid and a polybasic acid; and

(g) a mixed ester of a mixture of a monohydric alcohol and a polyhydric alcohol and a mixture of a monobasic acid and a polybasic acid.

Examples of the monohydric or polyhydric alcohols include those having a hydrocarbon group with 1 to 30, preferably 4 to 20, more preferably 6 to 18 carbon atoms.

Examples of the monobasic or polybasic acids include those having hydrocarbon group with 1 to 30, preferably 4 to 20, more preferably 6 to 18 carbon atoms.

Examples of the hydrocarbon group with 1 to 30 carbon atoms include hydrocarbon groups such as alkyl, alkenyl, cycloalkyl, alkylcycloalkyl, aryl, alkylaryl, and arylalkyl groups.

Examples of the alkyl group include those having preferably 4 to 20 carbon atoms, particularly preferably those having 6 to 18 carbon atoms. Examples of the alkenyl groups include those having preferably 4 to 20 carbon atoms, particularly preferably 6 to 18 carbon atoms.

Examples of the monohydric alcohol include monohydric alkyl alcohols having 1 to 30 carbon atoms (the alkyl groups may be straight-chain or branched); monohydric alkenyl alcohols having 2 to 40 carbon atoms (the alkenyl groups may be straight-chain or branched and the position of the double bond may vary) such as ethenol, propenol, butenol, hexenol, octenol, decenol, dodecenol, and octadecenol (oleyl alcohol); and mixtures thereof.

Specific examples of the polyhydric alcohols include dihyrdic alkyl or alkenyl diols having 2 to 30 carbon atoms (the alkyl or alkenyl groups may be straight-chain or branched, and the positions of the double bond and hydroxyl group of the alkenyl groups may vary) such as glycerin, trimethylolalkanes such as trimethylolethane, trimethylolpropane, and trimethylolbutane, erythritol, pentaerythritol, 1,2,4-butanetriol, 1,3,5-pentanetriol, 1,2,6-hexanetriol, 1,2,3,4-butanetetrol, sorbitol, adonitol, arabitol, xylytol, and mannitol, and polymers or condensated products thereof (for example, dimers through octamers of glycerine, such as diglycerin, triglycerine, and tetraglycerin, dimers through octamers of trimethylolpropane such as ditrimethylolpropane, dimers through tetramers of pentaerythritol such as dipentaerythritol, sorbitan, condensation compounds such as sorbitol glycerin condensation products (intermolecular condensation compounds, intramolecular condensation compounds or self-condensation compounds).

Alternatively, the above-described alcohols may be those produced by adding thereto an alkylene oxide having 3 to 10, preferably 2 to 4 carbon atoms or a polymer or copolymer thereof and then hydrocarbyl-etherifying or hydrocarbyl-esterifying the hydroxyl groups of the alcohols. Examples of the alkylene oxide having 3 to 10 carbon atoms include ethylene oxide, propylene oxide, 1,2-epoxybutane (α-butylene oxide), 2,3-epoxybutane (β-butylene oxide), 1,2-epoxy-1-methylpropane, 1,2-epoxyheptane, and 1,2-epoxyhexane. Among these alkylene oxides, preferred are ethylene oxide, propylene oxide, and butylene oxide, and more preferred are ethylene oxide and propylene oxide because of their excellent low friction properties. In the case of using two or more types of alkylene oxides, no particular limitation is imposed on the polymerization mode of the oxyalkylene groups, which may be random- or block-copolymerization. When an alkylene oxide is added to a polyhydric alcohol having 3 to 10 hydroxyl groups, it may be added to all or part of the hydroxyl groups.

The monobasic acid may be a fatty acid having a hydrocarbon group of 1 to 30 carbon atoms, which may be straight-chain or branched and saturated or unsaturated.

Examples of the above-described polybasic acid include saturated or unsaturated aliphatic dicarboxylic acids having 2 to 30 carbon atoms (the saturated or unsaturated aliphatic groups may be straight-chain or branched and the position of the unsaturated bonds may vary); saturated or unsaturated aliphatic tricarboxylic acids (the saturated or unsaturated aliphatic groups may be straight-chain or branched and the position of the unsaturated bonds may vary) such as propanetricarboxylic acid, butanetricarboxylic acid, pentanetricarboxylic acid, hexanetricarboxylic acid, heptanetricarboxylic acid, octanetricarboxylic acid, nonanetricarboxylic acid, decanetricarboxylic acid; and saturated or unsaturated alphatic tetracarboxylic acids (the saturated or unsaturated aliphatic group may be straight-chain or branched and the position of the unsaturated bonds may vary).

Component (B-2) used in the present invention may be any one of or a mixture of two or more types of ester-based base oils satisfying the above-described requirements or alternatively may be a mixture of one or more of ester-based base oils satisfying the above-described requirements and an ester-based base oil not satisfying the above-described requirements if the resulting mixture satisfies the above-described requirements.

Component (B-2) in the present invention is preferably a polyhydric alcohol ester-based base oil, particularly preferably is selected from esters of saturated or unsaturated monovalent fatty acids having 6 to 18, preferably 12 to 18 carbon atoms (these fatty acids may be straight-chain or branched and the position of the double bonds may vary) and polyhydric aliphatic alcohols.

Component (B-2) has a 100° C. kinematic viscosity of preferably 1.5 to 30 mm²/s, more preferably 2 mm²/s or higher and more preferably 20 mm²/s or lower, more preferably 15 mm²/s or lower, most preferably 12 mm²/S. Blend of an ester-based base oil with a 100° C. kinematic viscosity of 1.5 to 30 mm²/s renders it possible to significantly improve the fatigue life of bearings and gears.

No particular limitation is imposed on the pour point of Component (B-2), which is, however, preferably −20° C. or lower, more preferably −30° C. or lower, particularly preferably −40° C. or lower. The use of Component (B-2) with a pour point of −20° C. or lower can provide the resulting composition with excellent low friction characteristics at low temperature ranges, startability and fuel saving performance right after starting.

In the present invention, the lubricating base oil comprises a mineral base oil referred to as Component (A) and/or a synthetic base oil referred to as Component (B). When Components (A) and (B) are mixed, the content of Component (A) in the base oil is on the basis of the total mass of the base oil composition, preferably 40 percent by mass or more, more preferably 50 percent by mass or more, more preferably 60 percent by mass or more and preferably 90 percent by mass or less, more preferably 80 percent by mass or less, more preferably 70 percent by mass or less.

If the content is less than the above ranges, Component (A) fails to exhibit its viscosity temperature characteristics sufficiently. If the content is too large, the amount of Component (B) is too less and thus the base oil would be poor in fatigue life and low temperature viscosity characteristics achieved by the combination with Component (B).

When Component (B-1) is used as Component (B), the content of Component (B-1) that is a poly-α-olefin is on the basis of the total mass of the base oil composition preferably 2 to 60 percent by mass, more preferably 5 percent by mass or more, particularly preferably 10 percent by mass or more. Whilst, from the viewpoint of compatibility with sealing materials, the content is preferably 35 percent by mass or less, more preferably 30 percent by mass or less.

When Component (B-1) is a combination of Components (B-1-1) and (B-1-2), the content of Component (B-1-1) is on the basis of the total mass of the base oil composition preferably 3 percent by mass or more, more preferably 7 percent by mass or more, more preferably 10 percent by mass or more. Whilst, from the viewpoint of compatibility with sealing materials, the content is preferably 35 percent by mass or less, more preferably 20 percent by mass or less.

Whilst, the content of Component (B-1-2) is on the basis of the total mass of the base oil preferably 5 percent by mass or more, more preferably 7 percent by mass or more, more preferably 10 percent by mass or more. Whilst, from the viewpoint of compatibility with sealing materials, the content is preferably 20 percent by mass or less, more preferably 15 percent by mass or less.

The mass ratio ((B-1-1)/(B-1-2)) of Component (B-1-1) and Component (B-1-2) is preferably 0.2 or greater, more preferably 0.4 or greater from the viewpoint of low temperature viscosity characteristics and 10 or smaller, 5 or smaller, 2 or smaller from the viewpoint of viscosity index.

When Component (B-2) is used as Component (B), the content of Component (B-2) is on the basis of the total mass of the base oil preferably 5 percent by mass or more, more preferably 7 percent by mass or more, more preferably 10 percent by mass or more. Whilst, from the viewpoint of the swelling characteristics of a seal material, the content is preferably 60 percent by mass or less, more preferably 30 percent by mass or less.

The lubricating base oil of the lubricating oil composition of the present invention is preferably a lubricating base oil having been adjusted to have a 100° C. kinematic viscosity of 3 mm²/s or higher, preferably 5 mm²/s or higher, more preferably 8 mm²/s or higher, more preferably 12 mm²/s or higher, and 20 mm²/s or lower, preferably 18 mm²/s or lower, more preferably 16 mm²/s or lower.

The viscosity of the base oil gives a significant influence on fatigue life, and since a base oil with a higher viscosity basically prolong fatigue life but would be deteriorated in low temperature viscosity, an appropriate viscosity range exists.

The lubricating oil composition of the present invention contains Component (C) that is a friction modifier selected from the group consisting of amide-based and imide-based friction modifiers and derivatives thereof in an amount of 0.01 to 10 percent by mass on the basis of the total mass of the composition.

Examples of the amide-based friction modifier used as Component (C) include fatty acid amide-based friction modifiers such as amides of straight-chain or branched, preferably straight-chain fatty acids and ammonia, aliphatic monoamine or aliphatic polyamines.

One specific example of the amide-based friction modifier is a fatty acid amide compound containing one nitrogen atom and having at least one alkyl or alkenyl group of 10 to 30 carbon atoms. More specific examples include fatty acid amides produced by reacting a fatty acid having an alkyl or alkenyl group having 10 to 30 carbon atoms or an acid chloride thereof with a nitrogen-containing compound such as ammonia or an amine compound having in its molecules only a hydrocarbon group or hydroxyl-containing hydrocarbon group having 1 to 30 carbon atoms.

The amide-based friction modifier is particularly preferably an amide compound having its terminal ends that are amide groups, produced by reacting ammonia and a fatty acid.

Specific particularly preferable examples of (C-1) the fatty acid amide include lauric acid amide, myristic acid amide, palmitic acid amide, stearic acid amide, oleic acid amide, coconut oil fatty acid amide, synthetic mixed fatty acid amide having 12 or 13 carbon atoms, and mixtures thereof in view of their excellent friction reducing effect.

Specific preferable examples of (C-2) other amide-based friction modifier include those having an amide bond having 2 to 10, preferably 2 to 4, particularly preferably 2 nitrogen atoms and preferably 1 to 4, more preferably 1 or 2 oxygen atoms as represented by formula (1) below:

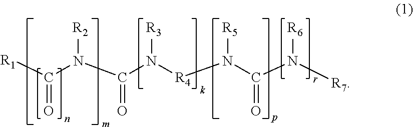

In formula (1), R₁ is an alkyl or alkenyl group having 10 to 30 carbon atoms, preferably a straight-chain alkyl or alkenyl group or a straight-chain alkyl or alkenyl group having one methyl group as a substituent. R₂ and R₃ are each independently hydrogen or an alkyl group having 1 to 3 carbon atoms, particularly preferably hydrogen. R₄ is an alkylene group having 1 to 4 carbon atoms, particularly preferably an alkylene group having 2 carbon atoms. R₅ and R₆ are each independently hydrogen or an alkyl group having 1 to 3 carbon atoms, particularly preferably hydrogen. R₇ is an alkyl or alkenyl group having 1 to 30 carbon atoms, preferably a straight-chain alkyl or alkenyl group having 10 to 30 carbon atoms. Preferably, k is an integer of 0 to 6, preferably 1 to 4, m is an integer of 0 to 2, and n, p and r are each independently an integer of 0 or 1.

In the most preferable format of formula (1), R₁ is a straight-chain alkyl or alkenyl group having 12 or more, more preferably 16 or more, most preferably 18 or more and 26 or fewer, more preferably 24 or fewer carbon atoms. The main chain is a straight-chain alkyl or alkenyl group, more preferably a group having methyl at the α-position of the carbonyl group. Preferably, R₇ is in the same format as that of R₁. R₁ and R₇ having 10 or more carbon atoms renders it possible to produce a lubricating oil composition with improved anti-NV properties. R₁ and R₇ having more than 30 carbon atoms is not preferable because the resulting composition would be degraded in viscosity characteristics at low temperatures.

Preferably, k is an integer of 2 or greater and 4 or smaller. Preferably, m is an integer of 0 or 1, most preferably 0. Preferably, p is an integer of 1.

Specific examples of other preferable formats of formula (1) include hydrazide (oleic acid hydrazide and the like), semicarbazide (oleyl semicarbazide and the like), urea (oleyl urea and the like), ureide (oleyl ureide and the like), allophanate amide (oleyl allophanate amide and the like), and derivatives thereof as exemplified in WO2005/037967 pamphlet.

Among these compounds, particularly preferred are one or more compounds selected from the group consisting of nitrogen-containing compounds represented by formulas (2) and (3) below and acid-modified derivatives thereof:

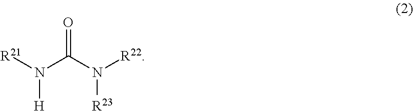

In formula (2), R²¹ is a hydrocarbon or functionalized hydrocarbon group having 1 to 30 carbon atoms, preferably a hydrocarbon or functionalized hydrocarbon group having 10 to 30 carbon atoms, more preferably an alkyl, alkenyl or functionalized hydrocarbon group having 12 to 24 carbon atoms, and particularly preferably an alkenyl group having 12 to 20 carbon atoms, and R²² and R²³ are each independently a hydrocarbon or functionalized hydrocarbon group having 1 to 30 carbon atoms or hydrogen, preferably a hydrocarbon or functionalized hydrocarbon group having 1 to 10 carbon atoms or hydrogen, more preferably hydrocarbon group having 1 to 4 carbon atoms or hydrogen, more preferably hydrogen.

Most preferred examples of nitrogen-containing compounds represented by formula (2) include urea compounds having an alkyl or alkenyl group having 12 to 24 carbon atoms, wherein R²¹ is an alkyl or alkenyl group having 12 to 24 carbon atoms, and R²² and R²³ are each hydrogen, such as dodecyl urea, tridecyl urea, tetradecyl urea, pentadecyl urea, hexadecyl urea, heptadecyl urea, octadecyl urea, and oleyl urea, and acid-modified derivatives thereof. Among these nitrogen-containing compounds, particularly preferable examples include oleyl urea (C₁₈H₃₅—NH—C(═O)—NH₂) and acid modified derivatives thereof (boric acid modified derivatives and the like).

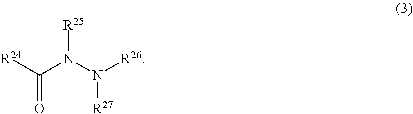

In formula (3), R²⁴ is a hydrocarbon or functionalized hydrocarbon group having 1 to 30 carbon atoms, preferably a hydrocarbon or functionalized hydrocarbon group having 10 to 30 carbon atoms, more preferably an alkyl, alkenyl or functionalized hydrocarbon group having 12 to 24 carbon atoms, and particularly preferably an alkenyl group having 12 to 20 carbon atoms, and R²⁵ through R²⁷ are each independently a hydrocarbon or functionalized hydrocarbon group having 1 to 30 carbon atoms or hydrogen, preferably a hydrocarbon or functionalized hydrocarbon group having 1 to 10 carbon atoms or hydrogen, more preferably a hydrocarbon group having 1 to 4 carbon atoms or hydrogen, more preferably hydrogen.

Specific examples of nitrogen-containing compounds represented by formula (3) include hydrazides having a hydrocarbon or functionalized hydrocarbon group having 1 to 30 carbon atoms, and derivatives thereof. The nitrogen-containing compounds are hydrazides having a hydrocarbon or functionalized hydrocarbon group having 1 to 30 carbon atoms when R²⁴ is a hydrocarbon or functionalized hydrocarbon group having 1 to 30 carbon atoms, and R²⁵ through R²⁷ are each hydrogen. The nitrogen-containing compounds are N-hydrocarbyl hydrazides (hydrocarbyl denotes hydrocarbon group) having a hydrocarbon or functionalized hydrocarbon group having 1 to 30 carbon atoms when R²⁴ and either one of R²⁵ through R²⁷ are each a hydrocarbon or functionalized hydrocarbon group having 1 to 30 carbon atoms and the rest of R²⁵ through R²⁷ are each hydrogen.

Most preferable examples of the nitrogen-containing compounds represented by formula (3) include hydrazide compounds having an alkyl or alkenyl group having 12 to 24 carbon atoms, wherein R²⁴ is an alkyl or alkenyl group having 12 to 24 carbon atoms and R²⁵, R²⁶ and R²⁷ are each hydrogen, such as dodecanoic acid hydrazide, tridecanoic acid hydrazide, tetradecanoic acid hydrazide, pentadecanoic acid hydrazide, hexadecanoic acid hydrazide, heptadecanoic acid hydrazide, octadecanoic acid hydrazide, oleic acid hydrazide, erucic acid hydrazide and acid-modified derivatives thereof (boric acid-modified derivatives). Among these nitrogen-containing compounds, particularly preferable examples include oleic acid hydrazide (C₁₇H₃₃—C(═O)—NH—NH₂) and acid modified derivatives thereof, erucic acid hydrazide (C₂₁H₄₁—C(═O)—NH—NH₂) and acid modified derivatives thereof.

Examples of amide-based friction modifiers in another format include those having amide as a functional group and still having a hydroxyl group or carboxylic acid group in the same molecule. These compounds also belong to the category of Component (D) described later. Component (C) that is amide in combination with the amide compound having an amide as a functional group and still having a hydroxyl group or carboxylic acid group in the same molecule is a more preferable format.

Specific examples of (C-3) an amide-based friction modifier having a hydroxyl group include fatty acid amides produced by reacting fatty acids having an alkyl or alkenyl group having 10 to 30 carbon atoms or acid chlorides thereof with nitrogen-containing compounds such as amine compounds containing only a hydroxyl group-containing hydrocarbon group having 1 to 30 carbon atoms per molecule.

The amide-based friction modifier is preferably a compound represented by formula (4):

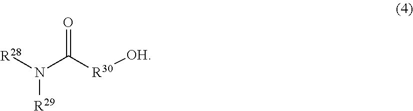

In formula (4), R²⁸ is a hydrocarbon or functionalized hydrocarbon group having 1 to 30 carbon atoms, preferably a hydrocarbon or functionalized hydrocarbon group having 10 to 30 carbon atoms, more preferably an alkyl, alkenyl or functionalized hydrocarbon group having 12 to 24 carbon atoms, and particularly preferably an alkenyl group having 12 to 20 carbon atoms, R²⁹ is a hydrocarbon or functionalized hydrocarbon group having 1 to 30 carbon atoms or hydrogen, preferably a hydrocarbon or functionalized hydrocarbon group having 1 to 10 carbon atoms or hydrogen, more preferably a hydrocarbon group having 1 to 4 carbon atoms or hydrogen, more preferably hydrogen, and R³⁰ is a hydrocarbon group or functionalized hydrocarbon group having 1 to 10 carbon atoms, preferably a hydrocarbon group having 1 to 4 carbon atoms, more preferably a hydrocarbon group having 1 or 2 carbon atoms, most preferably a hydrocarbon group having one carbon atom.

The compound represented by formula (4) may be synthesized for example by reacting a hydroxylic acid with an aliphatic amine. The hydroxylic acid is preferably an aliphatic hydroxylic acid, more preferably a straight-chain aliphatic α-hydroxylic acid. The α-hydroxylic acid is preferably glycolic acid. The aliphatic amine is preferably a compound exemplified as an amine-based friction modifier as described below.

Examples of (C-4) the amide compound having a carboxylic acid group in the same molecule include compounds represented by formula (5):

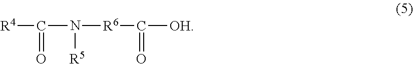

In formula (5), R⁴ and R⁵ are each independently hydrogen or an alkyl or alkenyl group having 1 to 30 carbon atoms, at least one of R⁴ and R⁵ is an alkyl or alkenyl group having 8 to 30 carbon atoms, and R⁶ is a single bond or an alkylene group having 1 to 4 carbon atoms.

In the present invention, specific examples of particularly preferable compounds represented by formula (5) include N-oleoylsarcosine represented by formula (6):

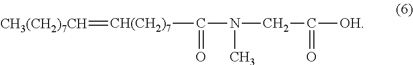

Examples of (C-5) the imide-based friction modifier include succinimide-based friction modifiers such as mono- and/or bis-succinimides having one or two straight-chain or branched, preferably branched hydrocarbon groups and succinimide-modified compounds produced by allowing such succinimides to react with one or more types selected from boric acid, phosphoric acid, carboxylic acids having 1 to 20 carbon atoms and sulfur-containing compounds.

Specific examples of the imide-based friction modifier include succinimides represented by formula (7) or (8) and derivatives thereof:

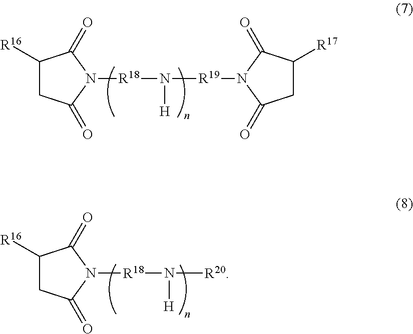

In formulas (7) and (8), R¹⁶ and R¹⁷ are each independently an alkyl or alkenyl group having 8 to 30, preferably 12 to 24 carbon atoms, R¹⁸ and R¹⁹ are each independently an alkylene group having 1 to 4, preferably 2 or 3 carbon atoms, R²⁰ is hydrogen or an alkyl or alkenyl group having 1 to 30, preferably 8 to 30 carbon atoms, and n is an integer of 1 to 7, preferably 1 to 3.

The content of Component (C) in the lubricating oil composition of the present invention is on the basis of the total mass of the composition 0.01 to 10 percent by mass, preferably 0.1 percent by mass or more, more preferably 0.3 percent by mass or more, and preferably 3 percent by mass or less, more preferably 2 percent by mass or less, more preferably 1 percent by mass or less. If the content of the friction modifier is less than 0.01 percent by mass, the friction reducing effect attained thereby is likely to be insufficient. If the content is more than 10 percent by mass, the effect of anti-wear additives is likely to be blocked or the solubility of additives are likely to be degraded.

The nitrogen content of Component (C) in the lubricating oil composition of the present invention is, on the basis of the total mass of the composition, preferably 0.0005 to 0.4 percent by mass, more preferably 0.001 to 0.3 percent by mass, particularly preferably 0.005 to 0.25 percent by mass. This is because anti-NV properties are not sufficiently exhibited if the nitrogen content is too less and the solubility is degraded, causing precipitation or turbidity if the nitrogen content is too large.

In addition to (C) the amide-based and/or imide-based friction modifier, the lubricating oil composition of the present invention further contains preferably (D) at least one or more types of friction modifiers selected from the group consisting of carboxylic acid-, alcohol-, and amine-based friction modifiers and derivative thereof in an amount of 0.01 to 10 percent by mass on the basis of the total mass of the composition.

Examples of (D-1) the carboxylic acid-based friction modifiers include straight-chain or branched, preferably straight-chain fatty acids, nitrogen-containing carboxylic acids having an alkyl or alkenyl group, fatty acid esters of fatty acids and aliphatic monohydric alcohols or aliphatic polyhydric alcohols, alkaline earth metal salt of the fatty acids (magnesium salt, calcium salt) and fatty acid metals salts such as zinc salts of the fatty acid.

Examples of (D-2) the alcohol-based friction modifier include straight-chain or branched, preferably straight-chain aliphatic monohydric alcohols or polyhydric alcohols. Particularly preferred are diol and triol, and particularly preferred is glycol.

Examples of (D-3) the amine-based friction modifier include aliphatic amine-based friction modifiers such as straight-chain or branched, preferably straight-chain aliphatic monoamines, straight-chain or branched, preferably straight-chain aliphatic polyamine, and alkyleneoxide adducts of these aliphatic amines.

The above-described friction modifiers (D-1) to (D-3) have in addition to their polar groups a hydrocarbon group. Unless otherwise stated, this hydrocarbon group is a straight-chain or branched alkyl or alkenyl group having 10 or more and 30 or fewer as the basic main chain. Friction modifiers with fewer branch is preferable, most preferably straight-chain but may have about one branch that is methyl group.

The polar groups of (D-1) to (D-3) may be present in the same compound.

Components (D-1) to (D-3) are more preferably used in combination.

The fatty acids referred to as Component (D-1) above may be fatty acids having a hydrocarbon group having 10 to 30 carbon atoms. The carbon number of the hydrocarbon group is preferably 12 or more, more preferably 16 or more, and preferably 24 or fewer, more preferably 20 or fewer. If the carbon number of the hydrocarbon group is fewer than 10, the resulting friction modifier would be poor in functions as a friction modifier. If the carbon number exceeds 30, the resulting lubricating oil composition would have some defects in respect of low temperature fluidity.

The hydrocarbon group may be straight-chain or branched and saturated or unsaturated, but is preferably fewer in branch, most preferably straight-chain hydrocarbon. However, the hydrocarbon may have a branch that is methyl group at the second from the terminal or at the alpha position of the carbonyl group.

The hydrocarbon may be saturated or unsaturated but has preferably one or fewer unsaturated bond per molecule and more preferably is saturated.

Specific examples include saturated aliphatic monocarboxylic acid having 10 to 30 carbon atoms such as decanoic acid, undecanoic acid, dodecanoic acid (lauric acid), tridecanoic acid, tetradecanoic acid (myristic acid), pentadecanoic acid, hexadecanoic acid (palmitic acid), heptadecanoic acid, octadecanoic acid (stearic acid), nonadecanoic acid, eicosanoic acid, heneicosanoic acid, docosanoic acid, tricosanoic acid, tetracosanoic acid, pentacosanoic acid, hexacosanoic acid, heptacosanoic acid, octacosanoic acid, nonacosanoic acid, and triacontanoic acid.

Examples of (D-1) the carboxylic acid-based friction modifier include esters of fatty acid having a straight-chain alkyl or alkenyl group having 10 to 30, preferably 12 to 24 carbon atoms and polyhydric alcohols.

Examples of the polyhydric alcohols also include polyhydric alcohol having 3 to 6 carbon atoms and dimers or trimers thereof. Specific examples include polyhydric alcohols such as glycerin, trimethylolethane, trimethylolpropane, pentaerythritol, and sorbitan, and dimers or trimers thereof such as diglycerin, ditrimethylolethane, ditrimethylolpropane, dipentaerythritol, triglycerin, tritrimethylolethane, tritrimethylolpropane, and tripentaerythritol.

The ester referred herein may be a full ester wherein all of the hydroxyl groups in a polyhydric alcohol are esterified or a partial ester wherein one or more of the hydroxyl groups remains unesterified. However, a partial ester is preferably used in the present invention because it is excellent in friction reducing effect.

Particularly in view of excellent friction characteristics, preferred are glycerin monooleate, glycerin dioleate, trimethylolethane monooleate, trimethylolethane dioleate, trimethylolpropane monooleate, trimethylolpropane dioleate, pentaerythritolmonooleate, pentaerythritol dioleate, pentaerythritol trioleate, sorbitan monooleate, sorbitan dioleate, sorbitan trioleate and mixtures thereof, most preferred are monooleates such as glycerin monooleate, trimethylolethane monooleate, trimethylolpropane monooleate, pentaerythritol monooleate, sorbitan monooleate and mixtures thereof.

Examples of the fatty acid metal salt of Components (D-1) include alkaline earth metal salts (magnesium salt, calcium salt) or zinc salts of fatty acids as mentioned above. Specific examples include calcium laurate, calcium myristate, calcium palmitate, calcium stearate, calcium oleate, coconut oil fatty acid calcium, synthetic mixed fatty acid calcium having 8 to 30 carbon atoms, zinc laurate, zinc myristate, zinc palmitate, zinc stearate, zinc oleate, coconut oil fatty acid zinc, synthetic mixed fatty acid zinc having 8 to 30 carbon atoms, and mixtures thereof.

Examples of (D-2) the alcohol-based friction modifier include monohydric alcohol or polyhydric alcohol. Particularly preferred are diol and triol, and particularly preferred is glycol.

Alcohol-based friction modifiers having a hydrocarbon group having 10 to 30 carbon atoms are preferably used. The carbon number of the hydrocarbon group is preferably 12 or more, more preferably 16 or more, and preferably 24 or fewer, more preferably 20 or fewer. If the carbon number of the hydrocarbon group is fewer than 10, the resulting friction modifier would be poor in functions as a friction modifier. If the carbon number exceeds 30, the resulting lubricating oil composition would have some defects in respect of low temperature fluidity.

The hydrocarbon group may be straight-chain or branched and saturated or unsaturated, but is preferably fewer in branch, most preferably straight-chain. However, the hydrocarbon may have about one branch that is methyl group.

The hydrocarbon may be saturated or unsaturated but has preferably one or fewer unsaturated bond per molecule and more preferably is saturated.

Examples of (D-3) the amine-based friction modifier include amine compounds having at least one hydrocarbon group having 10 to 30 carbon atoms such as alkyl or alkenyl group per molecule and derivatives thereof. The carbon number of the hydrocarbon group is preferably 12 or more, more preferably 16 or more, and preferably 24 or fewer, more preferably 20 or fewer. If the carbon number of the hydrocarbon group is fewer than 10, the resulting friction modifier would be poor in functions as a friction modifier. If the carbon number exceeds 30, the resulting lubricating oil composition would have some defects in respect of low temperature fluidity.

The hydrocarbon group may be straight-chain or branched and saturated or unsaturated, but is preferably fewer in branch, most preferably straight-chain. However, the hydrocarbon may have about one branch that is methyl group.

The hydrocarbon may be saturated or unsaturated but has preferably one or less unsaturated bond per molecule and more preferably is saturated.

Specific examples include aliphatic monoamines represented by formula (9) or alkyleneoxide adducts and aliphatic polyamines represented by formula (10) and derivatives thereof.

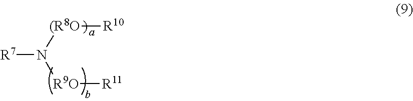

In formula (9), R⁷ is an alkyl or alkenyl group having 10 to 30, preferably 12 to 24 carbon atoms, R⁸ and R⁹ are each independently an alkylene group having 1 to 4, preferably 2 or 3 carbon atoms, R¹⁰ and R¹¹ are each independently hydrogen or a hydrocarbon group having 1 to 30 carbon atoms, a and b are each independently an integer of 0 to 10, preferably 0 to 6, and a+b=an integer of 0 to 10, preferably 0 to 6.

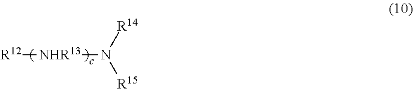

In formula (10), R¹² is an alkyl or alkenyl group having 10 to 30, preferably 12 to 24 carbon atoms, R¹³ is an alkylene group having 1 to 4, preferably 2 or 3 carbon atoms, R¹⁴ and R¹⁵ are each independently hydrogen or a hydrocarbon group having 1 to 30 carbon atoms, c is an integer of 1 to 5, preferably 1 to 4.

Specific examples of the amine compound and derivatives thereof include amine compounds such as lauryl amine, lauryl diethylamine, lauryl diethanolamine, dodecyldipropanolamine, palmitylamine, stearylamine, stearyltetraethylenepentamine, oleylamine, oleylpropylenediamine, oleyldiethanolamine, oleylsuccinimide, N-hydroxyethyloleylimidazolyne; alkyleneoxide adducts of these amine compounds; and mixtures thereof because of their excellent friction characteristics.

The content of Component (D) in the lubricating oil composition of the present invention is on the basis of the total mass of the composition preferably 0.01 to 10 percent by mass, more preferably 0.1 percent by mass or more, more preferably 0.3 percent by mass or more and preferably 3 percent by mass or less, more preferably 2 percent by mass or less, more preferably 1 percent by mass or less. If the content of Component (D) is less than 0.01 percent by mass, the friction reducing effect attained thereby is likely to be insufficient. If the content is more than 10 percent by mass, the effect of anti-wear additives is likely to be blocked or the solubility of additives are likely to be degraded.

The lubricating oil composition of the present invention contain preferably (E) a metallic detergent.

Alkaline earth metal detergents having a base number of 100 mgKOH/g or greater is preferably used as (E) the metallic detergent. Examples of the alkaline earth metal detergent include alkaline earth metal sulfonates, alkaline earth metal phenates, alkaline earth metal salicylates, alkaline earth metal phosphonates, or mixtures thereof.

Specific examples of the alkaline earth metal sulfonate include alkaline earth metal salts, particularly preferably magnesium salts and/or calcium salts of alkyl aromatic sulfonic acids, produced by sulfonating an alkyl aromatic compound having a molecular weight of 100 to 1,500, preferably 200 to 700. Specific examples of the alkyl aromatic sulfonic acids include petroleum sulfonic acids and synthetic sulfonic acids.

The petroleum sulfonic acids may be those produced by sulfonating an alkyl aromatic compound contained in the lubricant fraction of a mineral oil or may be mahogany acid by-produced upon production of white oil. The synthetic sulfonic acids may be those produced by sulfonating an alkyl benzene having a straight-chain or branched alkyl group, produced as a by-product from a plant for producing an alkyl benzene used as the raw material of a detergent or produced by alkylating polyolefin to benzene, or those produced by sulfonating alkylnaphthalenes such as dinonylnaphthalene. No particular limitation is imposed on the sulfonating agents used for sulfonating these alkyl aromatic compounds, which may be generally fuming sulfuric acids or sulfuric acid.

Examples of the alkaline earth metal phenates include alkaline earth metal salts, particularly preferably magnesium salts and/or calcium salts of an alkylphenol having at least one straight-chain or branched alkyl group having 4 to 30, preferably 6 to 18 carbon atoms, an alkylphenolsulfide produced by reacting the alkylphenol with sulfur or a Mannich reaction product of an alkylphenol produced by reacting the alkylphenol with formaldehyde.

Specific examples of the alkaline earth metal salicylates include alkaline earth metal salts, particularly preferably magnesium salts and/or calcium salts of alkyl salicylic acids having at least one straight-chain or branched alkyl group having 4 to 30, preferably 6 to 18 carbon atoms.

The alkaline earth metal sulfonates, alkaline earth metal phenates, and alkaline earth metal salicylates also include neutral salts (normal salts) produced by reacting alkyl aromatic sulfonic acids, alkylphenols, alkylphenolsulfides, Mannich reaction products of alkylphenols or alkylsalicylic acids directly with a metallic base such as an alkaline earth metal oxide or hydroxide or produced by converting alkyl aromatic sulfonic acids, alkylphenols, alkylphenolsulfides, Mannich reaction products of alkylphenols or alkylsalicylic acids to alkali metal salts such as sodium salts and potassium salts, followed by substitution with an alkaline earth metal salt; basic salts produced by heating these neutral salts (normal salts) with an excess amount of an alkaline earth metal salt or an alkaline earth metal base (alkaline earth metal hydroxide or oxide) in the presence of water; and overbased salts (ultrabasic salts) produced by reacting these neutral salts with a base such as an alkali metal or alkaline earth metal hydroxide in the presence of carbonic acid gas. These reactions are generally carried out in a solvent (aliphatic hydrocarbon solvents such as hexane, aromatic hydrocarbon solvents such as xylene, and light lubricating base oil).

Furthermore, Component (E) of the lubricating oil composition of the present invention is an overbased metallic detergent containing an excess metal salt such as carbon salt more preferably to the neutral salt detergents. Specifically, Component (E) is preferably a metallic detergent which has a metal ratio of 2.5 or larger, which metal ratio is a value obtained by dividing the mole number of an alkaline earth metal multiplied by the valence of 2, by the mole number of the soap group of the metallic detergent.

In the present invention, one or more metallic detergents selected from alkaline earth metal sulfonates, phenates and salicylates may be used as Component (E).

For the lubricating oil composition of the present invention, alkaline earth metal sulfonates or alkaline earth metal phenates are preferably used. Alkaline earth metal sulfonates are most preferably used. This is because among the metallic detergents of Component (E), sulfonates are most excellent in anti-wear properties and phenates are in the second place.

From the view point of anti-NV properties, sulfonates are most preferable.

As the alkaline earth metal, calcium and magnesium are preferable, but in the present invention, magnesium is most preferable. This is because they are most excellent in anti-NV properties.

The total base number of Component (E), i.e., alkaline earth metal detergent used in the lubricating oil composition of the present invention is preferably 100 mgKOH/g or greater, more preferably 140 mgKOH/g or greater, more preferably 200 mgKOH/g or greater and preferably 500 mgKOH/g or less, more preferably 450 mgKOH/g or less, more preferably 400 mgKOH/g or less. If the base number is less than 100 mgKOH/g, fatigue life prolonging effect cannot be expected. If the base number exceeds 500 mgKOH/g, the resulting lubricating oil composition would lack in stability.

The term “total base number” used herein denotes one measured by the perchloric acid potentiometric titration method in accordance with section 7 of JIS K2501 “Petroleum products and lubricants-Determination of neutralization number”.

No particular limitation is imposed on the content of Component (E) in the present invention, which is, however, usually on the basis of the total mass of the composition, preferably 0.4 percent by mass or less as metal. From such a view point, the upper limit of the content of the metallic detergent is on the basis of the total mass of the composition more preferably 0.3 percent by mass or less, more preferably 0.25 percent by mass or less, particularly preferably 0.2 percent by mass or less as metal. No particular limitation is imposed on the lower limit, which is, however, preferably 0.0001 percent by mass or more, more preferably 0.0005 percent by mass or more, particularly preferably 0.001 percent by mass or more.

Although metallic detergents are usually commercially available as diluted with a light lubricating base oil, it is preferable to use a metallic detergent whose metal content is from 1.0 to 20 percent by mass, preferably from 2.0 to 16 percent by mass.

The lubricating oil composition for a differential gear unit of the present invention further contains preferably (F) a sulfur-based extreme pressure additive and (G) a phosphorous-based extreme pressure additive.

Component (F), i.e., the sulfur-based extreme pressure additive is preferably a sulfurized olefin and/or a sulfurized ester and/or a sulfurized fats and oil, or dihydrocarbyl polysulfides.

Examples of the sulfurized olefin include compounds represented by formula (11):

R²—Sx—R²⁹ (11).

In formula (11), R²⁸ is an alkenyl group having 2 to 15 carbon atoms, R²⁹ is an alkyl or alkenyl group having 2 to 15 carbon atoms, x is an integer of 1 to 8.

The compound can be produced by reacting an olefin having 2 to 15 carbon atoms or a dimer to tetramer thereof with sulfur or a sulfurizing agent such as sulfur chloride. Such an olefin is preferably propylene, isobutene, or diisobutene.

Examples of sulfurized olefins in another form include dihydrocarbyl polysulfides. The dihydrocarbyl polysulfides are compounds represented by formula (12):

R³⁰—Sy—R³¹ (12).

In formula (12), R³⁰ and R³¹ are each independently an alkyl (including cycloalkyl) group having 1 to 20 carbon atoms, an aryl group having 6 to 20 carbon atoms, or an arylalkyl group having 7 to 20 carbon atoms and may be the same or different from each other, and y is an integer of 2 to 8.

Specific examples of R³⁰ and R³¹ include methyl, ethyl, n-propyl, isopropyl, n-butyl, isobutyl, sec-butyl, tert-butyl, various pentyl, various hexyl, various heptyl, various octyl, various nonyl, various decyl, various dodecyl, cyclohexyl, phenyl, naphthyl, tolyl, xylyl, benzyl, and phenetyl groups.

Preferred examples of the dihydrocarbyl polysulfide include dibenzyl polysulfide, di-tert-nonylpolysulfide, didodecylpolysulfide, di-tert-butylpolysulfide, dioctylpolysulfide, diphenylpolysulfide, and dicyclohexylpolysulfide.

Component (E), i.e., sulfur-based extreme pressure additive may be a thiadiazole. No particular limitation is imposed on the structure of the thiadiazole. However, examples of the thiadiazole include 1,3,4-thiadiazole compounds represented by formula (13), 1,2,4-thiadiazole compounds represented by formula (14) and 1,4,5-thidiazole compounds represented by formula (15):

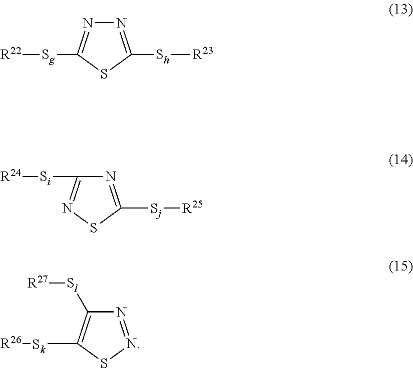

In formulas (13) to (15), R²², R²³, R²⁴, R²⁵, R²⁶ and R²⁷ may be the same or different from one another and are each independently hydrogen or a hydrocarbon group having 1 to 30 carbon atoms, and g, h, i, j, k and l are each independently an integer of 0 to 8.

Examples of the hydrocarbon group having 1 to 30 carbon atoms include alkyl, cycloalkyl, alkylcycloalkyl, alkenyl, aryl, alkylaryl and arylalkyl groups.

The amount of (F) the sulfur-based extreme pressure additive to be added in the present invention is on the basis of the total mass of the lubricating oil composition preferably 1 percent by mass or more, more preferably 1.2 percent by mass or more, more preferably 1.5 percent by mass or more and preferably 3 percent by mass or less, more preferably 2.5 percent by mass or less as sulfur. If the amount is less than 1 percent by mass, no anti-seizure properties is seen while if the amount exceeds 3 percent by mass, the composition is extremely degraded in oxidation stability.

Component (G), i.e., the phosphorous-based extreme pressure additive is preferably a blend of one or more types selected from phosphoric acid esters, phosphorous acid esters, fatty acid esters, fatty acid metal salts and derivatives thereof.

Examples of phosphoric acid esters and phosphorous acid esters include phosphoric acid monoesters, phosphoric acid diesters, phosphoric acid triesters, phosphorous acid monoesters, phosphorous acid diesters, and phosphorous acid triesters, more specific examples include phosphoric acid esters represented by formula (16) and phosphorous acid esters represented by formula (17).

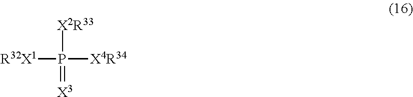

In formula (16), R³² is an alkyl or alkenyl group having 6 to 30, preferably 9 to 24 carbon atoms, R³³ and R³⁴ are each independently hydrogen or a hydrocarbon group having 1 to 30 carbon atoms, X¹, X², X³ and X⁴ are each independently oxygen or sulfur, and at least one of X′, X², X³ and X⁴ is oxygen.

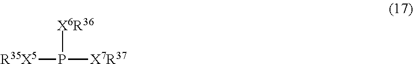

In formula (17), R³⁵ is an alkyl or alkenyl group having 6 to 30, preferably 9 to 24 carbon atoms, R³⁶ and R³⁷ are each independently hydrogen or a hydrocarbon group having 1 to 30 carbon atoms, X⁵, X⁶ and X⁷ are each independently oxygen or sulfur, and at least one of X⁵, X⁶ and X⁷ is oxygen.

The alkyl or alkenyl group for R³² and R³⁵ may be straight-chain or branched, but the carbon number thereof is 6 to 30, preferably 9 to 24.

If the carbon number of the an alkyl or alkenyl group is fewer than 6 or exceeds 30, the resulting composition would be poor in friction reducing effect.

Examples of the alkyl or alkenyl group include the above-described various alkyl or alkenyl groups. It is particularly preferably a straight-chain alkyl or alkenyl group having 12 to 18 carbon atoms such as lauryl, myristate, palmityl, stearyl and oleyl groups because of their excellent friction reducing effect.

Among these extreme pressure additives, acid phosphoric acid esters represented by formula (16) wherein at least one of R³³ and R³⁴ is hydrogen and acid phosphorous acid esters represented by formula (17) wherein at least one of R³⁶ and R³⁷ is hydrogen are preferably used because of their excellent friction reducing effect.

In the present invention, salts produced by allowing phosphorous compounds represented by formula (16) or (17) to react with a nitrogen compound to neutralize the whole or part of the remaining acid hydrogen are preferably used.

Examples of the nitrogen compound include ammonia, monoamine, diamine, and polyamine.

Preferred examples of the nitrogen compound include aliphatic amines having an alkyl or alkenyl group having 10 to 20 carbon atoms, which may be straight-chain or branched, such as decylamine, dodecylamine, dimethyldodecylamine, tridecylamine, heptadecylamine, octadecylamine, oleylamine, and stearyl amine.

The upper limit content of (G) the phosphorous-based extreme pressure additive in the lubricating oil composition of the present invention is as phosphorus, 0.3 percent by mass or less, preferably 0.2 percent by mass or less while the lower limit is 0.01 percent by mass or more, preferably 0.05 percent by mass or more because Component (G) is likely to inhibit wear.

If the content of the phosphorous-based extreme pressure additive exceeds 0.3 percent by mass as phosphorous, the resulting composition is extremely degraded in oxidation stability and base number retention properties.

In the lubricating oil composition of the present invention, no particular limitation is imposed on the mass ratio ((S)/(P)) of the content as sulfur (S) of Component (F) to the content as phosphorous (P) of Component (G) on the basis of the total mass of the composition, which is, however, preferably 4 or greater, more preferably 5 or greater, and preferably 100 or smaller, more preferably 80 or smaller, more preferably 70 or smaller.

Adjusting of the mass ratio to be within the above range renders it possible to produce a composition having well-balanced anti-wear properties and extreme pressure properties.

In the lubricating oil composition of the present invention, no particular limitation is imposed on the mass ratio ((M)/(P)) of the content as metal (M) of Component (D) to the content as phosphorous (P) of Component (G) on the basis of the total mass of the composition, which is however, preferably 0.05 to 30, more preferably 0.05 to 25, more preferably 0.06 to 20.

Adjusting of the mass ratio to be within the above range renders it possible to produce a composition which can maintain anti-NV properties for a long period of time.

If necessary, the lubricating oil composition of the present invention may contain various additives if the viscosity temperature characteristics, low temperature characteristics, anti-NV properties, anti-wear properties and anti-seizure properties are not impaired. No particular limitation is imposed on the additives which may, therefore, be any conventional additives other than those described above. Specific examples of such additives for lubricating oil include viscosity index improvers, metallic detergents, ashless dispersants, anti-oxidants, extreme pressure additives, antiwear agents, friction modifiers, pour point depressants, corrosion inhibitors, rust inhibitors, demulsifiers, metal deactivators, and anti-foaming agents. These additives may be used alone or in combination.

Unless otherwise stated, they are arbitrarily used each in an amount of 0.001 to 15 percent by mass on the basis of the total mass of the lubricating oil composition.

The lubricating oil composition of the present invention contain substantially no viscosity index improver. This means that the composition does not contain a viscosity index improver at all or even if it does, contains the same in an extremely smaller amount than a typical amount in which a viscosity index improver is expected to exhibit its effect (2 to 10 percent by mass). Specifically, the viscosity index improver is contained in an amount of preferably 1.0 percent by mass or less, more preferably 0.5 percent by mass or less, and most preferably is not contained at all. If the content of the viscosity index improver exceeds 1.0 percent by mass, it would cause the viscosity to reduce due to shear in use and is not preferable in terms of maintaining the minimum viscosity of a lubricating oil to exhibit fuel saving properties at the maximum.

Examples of the viscosity index improver include non-dispersant type or dispersant type viscosity index improvers. Specific examples of the non-dispersant type viscosity index improver include: homopolymers or copolymers of one or more types of monomers selected from alkylacrylates and alkylmethacrylates having 1 to 30 carbon atoms, olefins having 2 to 20 carbon atoms, styrene, methylstyrene, maleic anhydride ester and maleic anhydride amide; and hydrogenated compounds thereof.

Examples of the dispersant type viscosity index improver include: homopolymers or copolymers of one or more monomers selected from dimethylaminomethylmethacrylate, diethylaminomethylmethacrylate, dimethylaminoethylmethacylate, diethylaminoethylmethacrylate, 2-methyl-5-vinyl pyridine, morpholinomethylmethacrylate, morpholinoethylmethacrylate, N-vinylpyrrolidone, or hydrogenated compounds of the homopolymers or copolymers into which an oxygen-containing group is introduced and monomer components of the non-dispersant type viscosity index improver; and hydrogenated compounds thereof.

Examples of the metallic detergent other than Component (E) include sulfonate detergents, salicylate detergents, and phenate detergents, all having a base number of less than 100 mgKOH/g. Any of normal salt, basic salt or overbased salts of these detergents with an alkali metal or alkaline earth metal may be blended with the lubricating oil composition of the present invention. In use, any one or more type selected from these metallic detergents may be blended with the lubricating oil composition of the present invention.

The ashless dispersants may be any compound that is used as an ashless dispersant for lubricating oil. Examples of such compounds include nitrogen-containing compounds having in their molecules at least one alkyl or alkenyl group having 40 to 400, preferably 60 to 350 carbon atoms, bis-type or mono-type succinimides having an alkenyl group having 40 to 400 carbon atoms, preferably 60 to 350 carbon atoms, and modified products produced by allowing these compounds to react with boric acid, phosphoric acid, carboxylic acid or derivatives thereof, or a sulfur compound. Any one or more of these compounds may be used in combination.

The antioxidant may be any antioxidant that has been usually used in lubricating oil, such as phenol- or amine-based compounds. Specific examples of the antioxidant include alkylphenols such as 2-6-di-tert-butyl-4-methylphenol; bisphenols such as methylene-4,4-bisphenol(2,6-di-tert-butyl-4-methylphenol); naphthylamines such as phenyl-α-naphthylamine; dialkyldiphenylamines; zinc dialkyldithiophosphates such as zinc di-2-ethylhexyldithiophosphate; and esters of (3,5-di-tert-butyl-4-hydroxyphenyl) fatty acid (such as propionic acid) with a monohydric or polyhydric alcohol such as methanol, octadecanol, 1,6-hexanediol, neopentyl glycol, thiodiethylene glycol, triethylene glycol and pentaerythritol. Any one or more type selected from these antioxidants may be used in any amount, which is, however, usually from 0.01 to 5.0 percent by mass on the basis of the total mass of the lubricating oil composition.

Examples of sulfur-based extreme pressure additive include sulfur-based compounds other than Component (F) such as sulfurized fats and oils. Any one or more types selected from these compounds may be added in any amount, which is, however, 0.01 to 5.0 percent by mass on the basis of the total mass of the lubricating oil composition.

Other than the compounds described as (G) the phosphorous-based extreme pressure additive, alkyl zinc dithiophosphate and the like may also be used. No particular limitation is imposed on the content of these phosphorous-based additive, which is, however, usually preferably 0.005 to 0.2 percent by mass as phosphorous on the basis of the total mass of the lubricating oil composition. If the content is less than 0.005 percent by mass as phosphorous, the extreme pressure additive is less effective in anti-wear properties. If the content exceeds 0.2 percent by mass, the resulting composition is degraded in oxidation stability.

Examples of the friction modifier other than Components (C) and (D) include metal-based friction modifiers such as molybdenum dithiocarbamate, molybdenum dithiophosphate and the like.

Examples of the corrosion inhibitor include benzotriazole-, tolyltriazole-, thiadiazole-, and imidazole-types compounds.

Examples of the rust inhibitor include petroleum sulfonates, alkylbenzene sulfonates, dinonylnaphthalene sulfonates, alkenyl succinic acid esters, and polyhydric alcohol esters.

Examples of the demulsifier include polyalkylene glycol-based non-ionic surfactants such as polyoxyethylenealkyl ethers, polyoxyethylenealkylphenyl ethers, and polyoxyethylenealkylnaphthyl ethers.

Examples of the metal deactivator include imidazolines, pyrimidine derivatives, alkylthiadiazoles described as the sulfur-based extreme pressure additive, mercaptobenzothiazoles, benzotriazoles and derivatives thereof, 1,3,4-thiadiazolepolysulfide, 1,3,4-thiadiazolyl-2,5-bisdialkyldithiocarbamate, 2-(alkyldithio)benzoimidazole, and β-(o-carboxybenzylthio)propionitrile.

Examples of the anti-foaming agent include silicone oil with a 25° C. kinematic viscosity of 1000 to 100,000 mm²/s, alkenylsuccinic acid derivatives, esters of polyhydroxy aliphatic alcohols and long-chain fatty acids, aromatic amine salts of methylsalicylate and o-hydroxybenzyl alcohol.

When these additives are contained in the lubricating oil composition of the present invention, they are contained in an amount of preferably 0.1 to 20 percent by mass on the total composition mass basis.

The lubricating oil composition of the present invention has a 100° C. kinematic viscosity of necessarily 4.0 to 20 mm²/s, preferably 4.5 mm²/s or higher and 18 mm²/s or lower.

If the 100° C. kinematic viscosity is lower than 4.0 mm²/s, it would cause problems in oil film retainability at lubricating sites and evaporativity. Whilst, if the 100° C. kinematic viscosity exceeds 20 mm²/s, the resulting composition would lack from the viewpoint of fuel saving properties.

No particular limitation is imposed on the viscosity index of the lubricating oil composition of the present invention, which is, however, preferably 120 or greater, more preferably 130 or greater in view of fuel saving properties.

The −40° C. Brookfield (BF) viscosity of the lubricating oil composition of the present invention is preferably 150000 mPa·s or lower, more preferably 100000 mPa·s or lower. If the −40° C. Brookfield (BF) viscosity exceeds 150000 mPa·s, the resulting composition would be high in viscous resistance upon starting the engine and thus cause a degradation in fuel saving properties.

The Brookfield viscosity referred herein denotes the value measured in accordance with ASTM D2983.

The present invention is a lubricating oil composition that is particularly suitable for use in a differential gear unit with a limited-slip differential.

As described above, limited-slip differentials varied in mechanisms have been put in practical use. The limited-slip differential for which the present invention is most suitable is a type of differential that limits a difference in rotational speed between the left and right wheel shafts using frictional force generated between the metal parts of metal plates disposed between gears, between gears and a case or between axles.

Although “between the metal parts” is referred, the sliding surfaces thereof are generally subjected to various treatments such as quenching or coating.

For the most generally used mechanism, a difference in rotational speed is controlled by moving an axially movable plate referred to as “pressure plate” to press a plurality of plates disposed between the shafts to generate frictional force therebetween.

In addition to this mechanism, there is a so-called Quaife type or Torsen type limited-slip differential using a planetary gear mechanism with a helical gear. The Torsen type is further classified into a type generating more powerful differential limiting force and a type generating mild differential limiting force depending the arrangement of the helical gear (see various textbook with regard to details of these mechanisms).

The present invention is particularly suitable for use in the Torsen type and particularly suitable for the type which is improved in limitation of differential by pressing planetary gears against a gear case.

A Torsen type differential in which the lubricating oil composition of the present invention is suitably used is a driving force transmission system, comprising a plurality of planetary gears, a planetary carrier for supporting the plurality of planetary gears to be rotatable on their own axes and orbitally revolvable, and a pair of gears disposed coaxially with the planetary carrier and differentially rotatable via the planetary gears, wherein the lubricating oil of the present invention is applied between the sliding surfaces of the planetary gears and the planetary carrier.

That is, the differential with a limited-slip differential is a differential wherein a torque is distributed by the planetary gears, and a high contact pressure is applied to the sliding surfaces between the planetary gears and the planetary carrier. Even under such sever conditions, application of the lubricating oil composition of the present invention between these surfaces can improve the μ-V characteristics towards a positive gradient so as to ensure the quietness.

The above-described Torsen type differential may be regarded specifically as a center differential with a limited-slip differential with a structure as illustrated in FIG. 1.

A center differential with a limited-slip differential 1 illustrated in FIG. 1 has a substantially cylindrical housing 2. The housing 2 houses therein a planetary gear mechanism 7 including a ring gear 3, a sun gear 4 coaxially disposed in the ring gear 3, a plurality of planetary gears 5 to be meshed with the ring gear 3 and the sun gear 4, and a planetary carrier 6 supporting each planetary gear 5 to be rotatable on its own axis and orbitally revolvable.

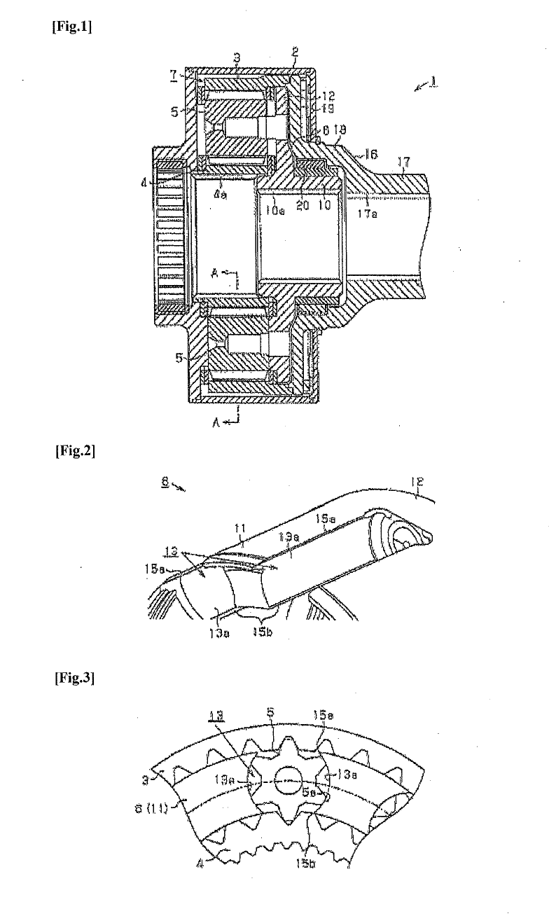

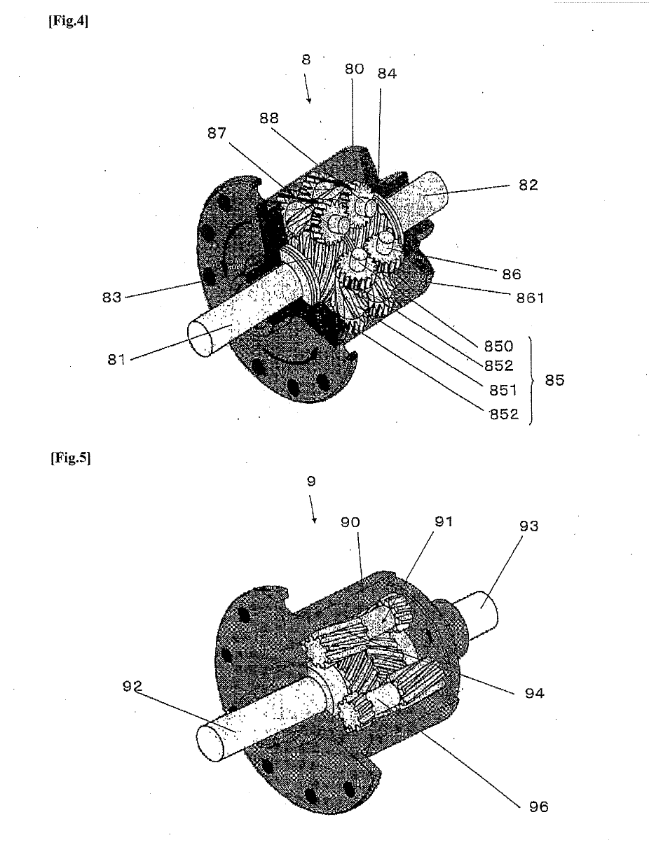

As shown in FIGS. 1 to 3, the planetary carrier 6 has a shaft portion 10 coaxially juxtaposed to the sun gear 4 (on the right side of FIG. 1) in a rotatable manner and a support portion 11 rotatably supporting each planetary gears 5. The shaft portion 10 is hollow and has a flange portion 12 formed on the outer periphery of the shaft portion to extend outwardly therefrom. The support portion 11 extends axially from the flange portion 12 so that it is coaxially disposed between the ring gear 3 and the sun gear 4.

The support portion 11 is formed in a substantially cylindrical shape and has a plurality of holding apertures 13 extending in the axial direction. These holding apertures 13 are spaced at equal intervals along the circumferential direction of the support portion 11. The holding apertures 13 have a circular shape in cross section, the inner diameter of which is substantially the same as the outer diameter of each planetary gear 5. The inner diameter of each holding aperture 13 is larger than the radial thickness of the support portion 11 such that two openings 15a and 15b which open to the outer and inner peripheries of the support portion 11, respectively are created on the surface 13a of each holding aperture 13. Each planetary gear 5 is inserted in each holding aperture 13 to be rotatably supported therein so that its tip surfaces 5a slidably contact the wall surfaces 13a of the holding aperture 13 and mesh with the ring gear 3 and the sun gear 4 through the openings 15a, 15b created on two radial sides of the wall surfaces 13a. In the center differential with a limited-slip differential 1, helical gears are used as the planetary gears 5.

As illustrated in FIG. 1, an output member 16 is coupled with the ring gear 3. The output member 16 has a shaft portion 17 which is coaxially juxtaposed to the shaft portion 10 of the planetary carrier 6 and which is hollow as with the shaft portion 10. The shaft portion 17 is merged at its end in the proximity of the planetary carrier 6 with a large diameter portion 18 coaxially disposed with the planetary carrier 6 in surrounding relation with the outer peripheral surface of the shaft 10 thereof, and the large diameter portion 18 has a flange portion 19 formed at the end toward the planetary carrier 6 to extend outwardly in the radial direction. The output member 16 rotates together with the ring gear 3 because the flange portion 19 is coupled with an axial end of the ring gear 3.

The housing 2 rotates together with the output member 16 and the ring gear 3 by being coupled with the large diameter portion 18 of the output member 16. The planetary carrier 6 is supported by a bearing (needle bearing) 20 interposed between the shaft 10 of the planetary carrier 6 and the large diameter portion 18 of the output member to be rotatable relative to the output member 16 and the ring gear 3. The sun gear 4 is hollow and has an end externally mounted in a rotatable manner on an end part of the shaft portion 10 of the planetary carrier 6. Accordingly, the sun gear 4 is supported rotatably relative to the planetary carrier 6.

The sun gear 4, the shaft portion 10 of the planetary carrier 6, and the shaft portion 17 of the output member 16 are provided with spline-fitting portions 4a, 10a, and 17a respectively formed in inner peripheries thereof. In the center differential with a limited-slip differential 1, the spline-fitting portion 10a formed in the shaft portion 10a of the planetary carrier 6 constitutes a drive torque input unit, and the spline-fitting portion 4a of the sun gear 4 and the spline-fitting portion 17a formed in the shaft portion 17 of the output member 16 respectively constitute a first output unit and a second output unit.

This is to say, drive torque input in the planetary carrier 6 is transmitted to the sun gear 4 and the ring gear 3 (output member 16) which are meshed with the planetary gears 5 at a predetermined distribution ratio through the rotation and revolution of the planetary gears 5 supported by the planetary carrier 6 while the differential motion is allowed. The center differential with a limited-slip differential 1 is constructed as a center differential for four-wheel drive vehicles. The drive shaft of the front wheels is linked to the sun gear 4, which is a first output portion whilst the drive shaft of the rear wheels is linked to the output member 16, which is a second output portion. The differential is constructed such that when torque reaction force is generated in the drive system of the vehicle, the differential is limited based on the thrust force resulting from the rotation between the gears meshing with each other and the frictional force between the surfaces which slidably contact each other, i.e., between the tooth tip surfaces 5a of each planetary gear 5 and the sliding surface of the planetary carrier 6 (wall surfaces 13a of the holding aperture 13).

The wall surfaces 13a of the holding apertures 13 serving as the slidably contacting surfaces are preferably nitrided (for example, ion nitriding or gas nitrocarburizing). The tooth tip surfaces 5a of each planetary gear 5 are preferably treated so to have a multilayer film of tungsten carbide/diamond-like carbon formed thereon.

The sliding surfaces of the center differential with a limited-slip differential 1 illustrated in FIGS. 1 to 3 are not only sliding surfaces of the planetary gears 5 and the housing 2 but also surfaces of the gears sliding with each other and sliding surfaces of the gears and the housing (washer provided in the housing). Therefore, these surfaces are also preferably nitrided (for example, ion nitriding or gas nitrocarburizing) and treated to have a tungsten carbide/diamond-like carbon film formed thereon.

The lubricating oil composition of the present invention may be used in differentials with a limited-slip differential illustrated in FIGS. 4, 5 and 6 as well as the differential with a limited-slip differential illustrated in FIGS. 1 to 3.

A differential with a limited-slip differential 8 illustrated in FIG. 4 has a housing 80 rotatable on one or the other of a pair of drive shafts 81 and 82. Side gears 83 and 84 formed as worm gears or helical gears are coupled with inner end parts of the two drive shafts. The housing 80, the pair of drive shafts, and the side gears 83 and 84 are rotatable about a common axis line.

Coupling gears 85, 86, 87, and 88 are operably coupled so that the two side gears 83 and 84 rotate by an equal amount in opposite directions relative to the housing 80. The coupling gears 85 to 88 each forms a train of gears and couples the two side gears 83 and 84 with each other. The housing 80 has a pedestal, and the pedestal has windows formed therein for the coupling gears respectively paired to be located away from each other through equal angles in two different directions from the side gears. The coupling gears are each retained in the window to be rotated on an axis line thereof by a journal pin 850. The journal pin 850 is supportably inserted in a hole formed in the pedestal.

The coupling gears 85 to 88 each has an intermediate gear portion 851 formed as a worm wheel (though the gear 85 alone is illustrated with reference numerals in FIG. 1, the other gears 86 to 88 are similarly structured), and two terminal gear portions 852 formed as spur gears. The intermediate gear portion 851 of the coupling gear 85 has teeth to be meshed with teeth of the side gear 83. The terminal gear portions 852 of the coupling gear each has teeth to be meshed with teeth of a corresponding gear portion of the coupling gear 86. An intermediate gear portion 861 of the coupling gear 86 has teeth to be meshed with teeth of the side gear 84.

According to the present embodiment, sliding surfaces are defined between the coupling gears 85 to 88 and the side gears 83, 84, between the pair of drive shafts 81 and 82, between the drive shafts 81, 82 and the housing 80 (washer provided therein), between axial end faces of the coupling gears 85 to 88 and the housing 80, and between the journal pins 850 of the coupling gears 85 to 88 and the housing 80.

According to the present embodiment, wall surfaces of the windows, which are sliding surfaces slidably contacted by the coupling gears 85 to 88, are preferably nitrided, and the tooth tip surfaces of the coupling gears 85 to 88 are treated to have a multilayer film of tungsten carbide/diamond-like carbon formed thereon.

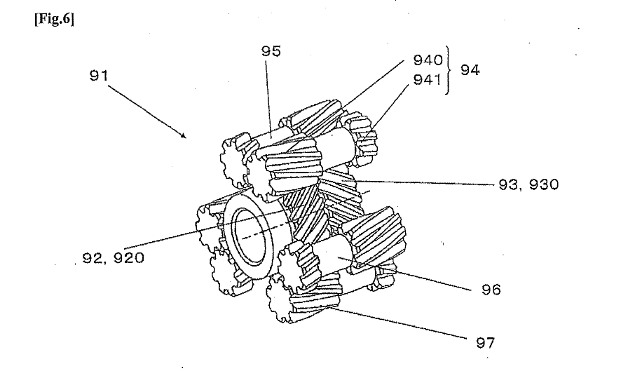

A differential with a limited-slip differential 9 illustrated in FIGS. 5 and 6 has a planetary gear mechanism 91 supported inside a housing 90, wherein the gear mechanism 91 couples a pair of drive shafts 92 and 93 with each other so that these shafts are rotatable in opposite direction relative to the housing 90. The gear mechanism 91 has a pair of side gears 920 and 930 respectively coupled with the drive shafts 92 and 93, and plurality of pairs of planetary gears 94 to 97. The planetary gears 94 have portion 940 to be meshed with the side gear 920 and portion 941 to be meshed with each other.

The side gears 920, 930 have teeth tilting in a direction through an equal tilting angle relative to a common rotational axis (for example, tilting to right or left). A thrust force is generated depending on a torque transmitted from the housing 90 to the drive shafts 92, 93.

According to the present embodiment, sliding surfaces are defined between the planetary gears 94 to 97 and the housing 90, between the pair of drive shafts 92 and 93, between the drive shafts 92, 93 and the housing 90 (washer provided therein), between axial end faces of the planetary gears 94 to 97 and the housing 90, and between the planetary gears 94 to 97 and the side gears 920, 930.

According to the present embodiment, wall surfaces of the housing 90 slidably contacted by the planetary gear 94 to 97 are preferably nitrided, and the tooth tip surfaces of the planetary gear 94 to 97 are treated to have a multilayer film of tungsten carbide/diamond-like carbon formed thereon.

When any of the sample oils is applied to between the sliding surfaces according to these modified embodiments, remarkable quietness (μ-V characteristics with positive gradient) can be attained.

Either one of a pair of friction members sliding with each other, used in the sliding surfaces constituting the limited-slip differential preferably has a diamond-like carbon film formed thereon. Sliding movement of a friction member under severe conditions of high contact pressures or high temperatures wears the sliding surface of the friction member. The wear of the friction member can be suppressed by forming a diamond-like carbon film (DLC film) on the sliding surface. The DLC film is not very aggressive against an opponent member and thus can delay the rate of deterioration of the lubricating oil.

The DLC film may be formed on the sliding surface in a manner similar to any conventional DLC films. The film thickness of the DLC film may be suitably determined depending on sliding conditions of the friction members.

Either one of the sliding surfaces of a pair of friction members sliding with each other used in the present invention preferably has a tungsten carbide/diamond-like carbon film formed thereon, and the other sliding surface is preferably nitrided. Furthermore, the other sliding surface is preferably made from an iron-based metal and then nitrided.

Similarly to the formation of the DLC film, the tungsten carbide/diamond-like carbon film (WC/C film) formed on the sliding surface can suppress the wear of the friction member. The WC/C film includes a multilayered structure where a tungsten carbide-enriched layer and a diamond-like carbon-enriched layer are alternately stacked on each other. The multilayered structure where the two layers are alternately stacked can prevent the friction members from wearing.

When the other sliding surface is nitrided, a nitrided film is formed thereon. The nitrided film has a high degree of hardness and thus can prevent the friction member from wearing against attack from the friction member having the WC/C film formed thereon.

No particular limitation is imposed on the method for forming the DLC film and the WC/C film, and these film may, therefore, be formed by any conventional methods. The film thicknesses of these films may be suitably determined without limitation depending on use conditions of the friction members.

The sliding surface of either one of a pair of friction members sliding against each other is preferably made from an iron-based metal, and the sliding surface of the other friction member is preferably nitrided. In the friction member used in the present invention, even though neither of the DLC film nor the WC/C film is formed thereon, the above-described lubricating oil can still perform anti-NV properties.

### EXAMPLES

Hereinafter, the present invention will be described in more detail by way of the following examples, which should not be construed as limiting the scope of the invention.

### Examples 1 to 9 and Comparative Examples 1 to 7

Various lubricating base oils and additives and their amounts and properties are set forth in Table 1. The amounts of base oils (percent by mass) and each additive (percent by mass) are based on the total mass of the lubricating oil composition.

The anti-NV properties and life thereof of each of the resulting composition were evaluated with a test (1) described below. The extreme pressure properties of each oil composition was evaluated with an extreme pressure test described in (2) below.

(1) Test for Evaluating Anti-NV Properties and Life Thereof

Under the following conditions, anti-NV properties were evaluated.

Test apparatus: LFW-1 test apparatus

block: nitrided material, ring: DLC-treated material

slipping velocity 0.02 4→0.011→0.005 m/s

Determination of anti-NV properties: by the ratio of μ at 0.024 m/s and μ at 0.005 m/s

A composition was rated as having anti-NV properties when it is 1 or greater in the above friction coefficient ratio.

Life of anti-NV properties was evaluated by the anti-NV properties of a sample oil degraded in an ISOT test apparatus.

ISOT degrading temperature condition: 120° C.

Determination of life of anti-NV properties: determined by the friction coefficient ratio of a degraded oil after a 96 hour degradation period

(2) Test for Extreme Pressure Properties

(a) Weld load (WL) of each of the compositions at a rotating speed of 1800 rpm was measured using a high-speed four-ball tester in accordance with ASTM D 2783.

(3) Anti-NV Properties in Torsen Actual Device

Contact pressure: 270 MPa

Circumferential velocity: friction coefficients (μ2, μ80) were measured at 4.62 mm/s (2 rpm), 184.77 mm/s (80 rpm)

Determination of anti-NV properties: if μ80/μ2>1.07, the composition was rated as having anti-NV properties.

TABLE 1

| | | 100° C. kinematic | | | | | | | | |
|---|---|---|---|---|---|---|---|---|---|---|
| | | viscosity(mm²/s) | Example 1 | Example 2 | Example 3 | Example 4 | Example 5 | Example 6 | Example 7 | Example 8 |
| | Mineral oil (wt %) | | | | | | | | | |
| | Low viscosity mineral oil⁽¹⁾ | 4.2 | 44.7 | 45.6 | 45.5 | 44.8 | 44.6 | 43.7 | 21 | 19 |
| | Low viscosity mineral oil⁽²⁾ | 6.2 | 44.7 | 45.6 | 45.5 | 44.8 | 44.6 | 43.7 | | |
| | Poly-α-olefin (PAO) (wt %) | | | | | | | | | |
| | Low viscosity PAO | 4.0 | | | | | | | 14 | 14 |
| | Low viscosity PAO | 6.0 | | | | | | | | |
| | High viscosity PAO | 100 | | | | | | | 30.8 | 29 |
| | High viscosity PAO | 1100 | | | | | | | | |
| | Polyol ester (wt %)⁽³⁾ | 10 | | | | | | | 20 | 20 |
| | Dibasic acid ester (wt %) | 3.0 | | | | | | | | |
| Polysulifide (wt %)⁽⁴⁾ | | | 5.0 | 5.0 | 5.0 | 5.0 | 5.0 | 5.0 | 5.0 | 5.0 |
| Acid phosphoric acid ester amine salt (wt %)⁽⁵⁾ | | | 1.2 | 1.2 | 1.2 | 1.2 | 1.2 | 1.2 | 1.2 | 5.0 |
| Friction modifier | | | | | | | | | | |
| Alkylamine (wt %) ⁸⁾ | | | | | 0.2 | | | 1.0 | 0.5 | 0.5 |
| Fatty acid (wt %) ⁹⁾ | | | 0.3 | 0.3 | 0.3 | 0.3 | 0.3 | 0.3 | 0.5 | 0.5 |
| Amide A (wt %) ¹⁰⁾ | | | 0.1 | 0.3 | 0.3 | 1.0 | 2.0 | 2.0 | 3.0 | |
| Amide B (wt %) ¹¹⁾ | | | | | | | | | | 3.0 |
| Alcohol (wt %) ¹²⁾ | | | | | | 0.3 | 0.3 | | | |
| Metallic detergent (wt %)⁽⁶⁾ | | | 2.0 | 0.05 | 0.1 | 0.6 | 0.1 | 1.2 | 2.0 | 2.0 |
| Other additives (wt %)⁽⁷⁾ | | | 2.0 | 2.0 | 2.0 | 2.0 | 2.0 | 2.0 | 2.0 | 2.0 |
| | Base oil | 40° C. kinematic | 27 | 27 | 27 | 27 | 27 | 27 | 103 | 103 |
| | | viscosity, mm²/s | | | | | | | | |
| | | 100° C. kinematic | 5 | 5 | 5 | 5 | 5 | 5 | 15 | 15 |
| | | viscosity, mm²/s | | | | | | | | |
| | | Viscosity index | 130 | 130 | 130 | 130 | 130 | 130 | 153 | 155 |

| | | | | | | | | |
|---|---|---|---|---|---|---|---|---|
| 40° C. kinemaitc viscosity, mm²/s | 31 | 31 | 31 | 31 | 31 | 31 | 103 | 103 |
| 100° C. kinemaitc viscosity, mm²/s | 6 | 6 | 6 | 6 | 6 | 6 | 15 | 15 |
| Viscosity index | 132 | 130 | 130 | 129 | 129 | 128 | 152 | 154 |
| BF viscosity (−40° C.), mPa · s | 17,000 | 17,000 | 18,000 | 19,000 | 20,000 | 22,000 | 91,000 | 85,000 |
| Sulfur content (wt %) | 1.2 | 1.2 | 1.2 | 1.2 | 1.2 | 1.2 | 1.2 | 1.2 |
| Phosphorus content (wt %) | 0.06 | 0.06 | 0.06 | 0.06 | 0.05 | 0.06 | 0.06 | 0.25 |
| S/P ratio | 20 | 20 | 20 | 20 | 20 | 20 | 20 | 5 |
| P/M ratio | 0.30 | 12 | 6 | 1.0 | 6.0 | 0.5 | 0.30 | 1.3 |
| N content from friction modifier (wt %) | 0.02 | 0.03 | 0.04 | 0.08 | 0.14 | 0.16 | 0.22 | 0.14 |
| Alkaline earth metal content (wt %) | 0.20 | 0.01 | 0.01 | 0.06 | 0.01 | 0.12 | 0.20 | 0.20 |
| Initial anti-NV properties | 1.020 | 1.021 | 1.035 | 1.025 | 1.026 | 1.040 | 1.028 | 1.039 |
| Life of anti-NV properties | 1.004 | 1.010 | 1.005 | 1.015 | 1.020 | 1.025 | 1.013 | 1.030 |
| High-speed four-ball test WL, N | 3089 | 3089 | 3089 | 3089 | 3089 | 4903 | 3089 | 3089 |
| Torsen actual device Initial anti-NV properties | — | — | — | 1.121 | — | — | 1.123 | — |
| Torsen actual device ISOT test (120° C.) | — | — | — | 1.095 | — | — | 1.079 | — |
| anti-NV properties after 48 hrs | | | | | | | | |

| | | | Compar- | Compar- | Compar- | Compar- | Compar- | Compar- | Compar- |
|---|---|---|---|---|---|---|---|---|---|
| | 100° C. kinematic | | ative | ative | ative | ative | ative | ative | ative |
| | viscosity(mm²/s) | Example 9 | Example 1 | Example 2 | Example 3 | Example 4 | Example 5 | Example 6 | Example 7 |
| Mineral oil (wt %) | | | | | | | | | |
| Low viscosity mineral oil⁽¹⁾ | 4.2 | | 45.9 | 45.9 | 45.7 | 45.7 | 45.7 | 45.6 | 22 |
| Low viscosity mineral oil⁽²⁾ | 6.2 | | 45.9 | 45.9 | 45.7 | 45.7 | 45.7 | 45.6 | |
| Poly-α-olefin (PAO) (wt %) | | | | | | | | | |
| Low viscosity PAO | 4.0 | | | | | | | | 14 |
| Low viscosity PAO | 6.0 | 35.8 | | | | | | | |
| High viscosity PAO | 100 | 15 | | | | | | | 32 |
| High viscosity PAO | 1100 | 2 | | | | | | | |
| Polyol ester (wt %)⁽³⁾ | 10 | 13 | | | | | | | 20 |
| Dibasic acid ester (wt %) | 3.0 | 6 | | | | | | | |
| Polysulifide (wt %)⁽⁴⁾ | | 10.0 | 5.0 | 5.0 | 5.0 | 5.0 | 5.0 | 5.0 | 5.0 |
| Acid phosphoric acid ester amine salt (wt %)⁽⁵⁾ | | 5.0 | 1.2 | 1.2 | 1.2 | 1.2 | 1.2 | 1.2 | 5.0 |
| Friction modifier | | | | | | | | | |
| Alkylamine (wt %) ⁸⁾ | | 2.0 | | | 0.3 | | | | |
| Fatty acid (wt %) ⁹⁾ | | 1.0 | | | | 0.3 | | 0.3 | |
| Amide A (wt %) ¹⁰⁾ | | 5.0 | | | | | | | |
| Amide B (wt %) ¹¹⁾ | | | | | | | | | |
| Alcohol (wt %) ¹²⁾ | | | | | | | 0.3 | 0.3 | |
| Metallic detergent (wt %)⁽⁶⁾ | | 3.2 | | 0.1 | 0.1 | 0.1 | 0.1 | | |
| Other additives (wt %)⁽⁷⁾ | | 2.0 | 2.0 | 2.0 | 2.0 | 2.0 | 2.0 | 2.0 | 2.0 |
| Base oil | 40° C. kinematic | 106 | 27 | 27 | 27 | 27 | 27 | 27 | 106 |
| | viscosity, mm²/s | | | | | | | | |
| | 100° C. kinematic | 15 | 5 | 5 | 5 | 5 | 5 | 5 | 15 |
| | viscosity, mm²/s | | | | | | | | |
| | Viscosity index | 150 | 130 | 130 | 130 | 130 | 130 | 130 | 150 |

| | | | | | | | | |
|---|---|---|---|---|---|---|---|---|
| 40° C. kinemaitc viscosity, mm²/s | 106 | 31 | 31 | 31 | 31 | 31 | 31 | 103 |
| 100° C. kinemaitc viscosity, mm²/s | 15 | 6 | 6 | 6 | 6 | 6 | 6 | 15 |
| Viscosity index | 148 | 132 | 131 | 130 | 130 | 130 | 130 | 152 |
| BF viscosity (−40° C.), mPa · s | 95,000 | 17,000 | 17,000 | 18,000 | 18,000 | 20,000 | 22,000 | 89,000 |
| Sulfur content (wt %) | 2.4 | 1.2 | 1.2 | 1.2 | 1.2 | 1.2 | 1.2 | 1.2 |
| Phosphorus content (wt %) | 0.25 | 0.06 | 0.06 | 0.06 | 0.06 | 0.06 | 0.06 | 0.25 |
| S/P ratio | 10 | 20 | 20 | 20 | 20 | 20 | 20 | 5 |
| P/M ratio | 0.78 | | 6 | 6 | 6 | 6 | | |
| N content from friction modifier (wt %) | 0.40 | | | 0.01 | 0.01 | 0.01 | 0.02 | |
| Alkaline earth metal content (wt %) | 0.32 | | 0.01 | 0.01 | 0.01 | 0.01 | | |
| Initial anti-NV properties | 1.045 | 1.010 | 1.010 | 1.018 | 1.018 | 1.013 | 1.022 | 1.012 |
| Life of anti-NV properties | 1.032 | 0.984 | 0.990 | 0.987 | 0.987 | 0.985 | 0.987 | 0.984 |
| High-speed four-ball test WL, N | 3923 | 3089 | 3089 | 3089 | 3089 | 3089 | 3089 | 3089 |
| Torsen actual device Initial anti-NV properties | — | — | — | 1.066 | — | — | — | — |
| Torsen actual device ISOT test (120° C.) | — | — | — | 1.045 | — | — | — | — |
| anti-NV properties after 48 hrs | | | | | | | | |

⁽¹⁾% CP = 78%, % CN = 22%, % CA = 0%, tertiary carbon amount 7.9%
⁽²⁾% CP = 78%, % CN = 22%, % CA = 0%, tertiary carbon amount 7.6%
⁽³⁾ester of trimethylol propane and fatty acid
Structure of dibasic acid ester: full ester of adipic acid and 2-ethyllhexanol
⁽⁴⁾Sulfur content = 24%
⁽⁵⁾neutralized product of phosphoric acid ester of oleyl alcohol and phoshoric aicd and phosphorus acid and alkylamine (C12 saturated alkyl)
⁽⁶⁾Mg sulfonate TBN = 400 mgKOH/g
⁽⁷⁾antioxidant (amine, phenol-based)1% dispersant (alkenylsuccinimide)0.4% pour point depressant (PMA) 0.3% reminder (rust inhibitor, anti-foaming agent, corrosion inhibitor) 0.3%
⁸⁾ Alkylamine (wt %) Oleyl amine
⁹⁾ Fatty acid (wt %) Oleic acid
¹⁰⁾ Amide A (wt %) compound represented by formula (1) R1 and R7: α-methylhexadecyl, m = r = 0, R3 = R5 = hydrogen, R4 = ethylene, k = 4, p = 1
¹¹⁾ Amide B (wt %) compound represented by formula (4) R28, R29: C12, C14mix, R30: methylene
¹²⁾ alcohol (wt %) glycol monooleate

### INDUSTRIAL APPLICABILITY

The lubricating oil composition of the present invention is a non-conventional fuel saving lubricating oil composition with anti-NV properties that is extremely suitable for a differential gear unit, particularly a differential gear unit with a limited-slip differential.

1. A lubricating oil composition for a differential gear unit comprising a base oil comprising (A) a mineral oil and/or (B) a synthetic oil and (C) a friction modifier selected from the group consisting of amide- and imide-based friction modifiers and derivative thereof in an amount of 0.01 to 10 percent by mass on the basis of the total mass of the composition.

2. The lubricating oil composition for a differential gear unit according to claim 1 wherein Component (A) has a 100° C. kinematic viscosity of 3 to 10 mm²/s.

3. The lubricating oil composition for a differential gear unit according to claim 1 wherein Component (B) is (B-1) a poly-α-olefin having a 100° C. kinematic viscosity of 3 to 2000 mm²/s and/or a hydrogenated compound thereof and/or (B-2) an ester base oil having a 100° C. kinematic viscosity of 1.5 to 30 mm²/s.

4. The lubricating oil composition for a differential gear unit according to claim 1 further comprising (D) at least one or more types of friction modifiers selected from the group consisting of carboxylic acids, alcohols, amines and derivatives thereof in an amount of 0.01 to 10 percent by mass on the basis of the total mass of the composition.

5. The lubricating oil composition for a differential gear unit according to claim 1 further comprising (E) a metallic detergent in an amount of 0.0001 to 0.4 percent by mass as metal on the basis of the total mass of the composition.

6. The lubricating oil composition for a differential gear unit according claim 1 further comprising (F) a sulfur-based extreme pressure additive and (G) a phosphorous-based extreme pressure additive in amounts of 1 to 3 percent by mass as sulfur and 0.01 to 0.3 percent by mass as phosphorous, respectively on the basis of the total mass of the composition.

7. A differential gear unit wherein it has a limited-slip differential limiting differential by allowing sliding members to slide and the sliding members are lubricated with the lubricating oil composition according to claim 1.

8. The differential gear unit according to claim 7 wherein the sliding surfaces of the sliding members of the limited-slip differential are treated to have a diamond-like carbon film or a tungsten carbide/diamond-like carbon film formed thereon or are nitrided.

9. The differential gear unit according to claim 8 wherein either the sliding members or the corresponding sliding members in the limited-slip differential have sliding surfaces with a diamond-like carbon film or a tungsten carbide/diamond-like carbon film formed thereon and the others have nitrided sliding surfaces.

10. The differential gear unit according to claim 7 wherein said limited-slip differential has a planetary gear mechanism.

11. The differential gear unit according to claim 7 wherein it has said limited-slip differential comprising the planetary gear mechanism comprising a plurality of planetary gears and a planetary carrier supporting the plurality of planetary gears so as to be rotatable on their own rotational axes and orbitally revolvable and the differential of the differential gear unit is limited by sliding of the planetary gears and planetary carrier relative to each other.
